(19) United States
(12) Patent Application Publication
(10) Pub. No.: US 2011/0282728 A1
(43) Pub. Date: Nov. 17, 2011

(54) SYSTEM AND METHOD FOR ENGAGING AND ACQUIRING CUSTOMERS

(76) Inventors: Sarah Bingham, Brighton, MA (US); Dow K. Hardy, Marlborough, MA (US); Peter D. Kovacs, Waxhaw, NC (US); Francis J. Lichtenberger, Winchester, MA (US); Matthew S. Ross, Needham Heights, MA (US); Nathan Short, Richmond, RI (US); Brian Silver, Austin, TX (US); Scott N. Weller, Windham, NH (US)

(21) Appl. No.: 12/980,681

(22) Filed: Dec. 29, 2010

Related U.S. Application Data
(63) Continuation-in-part of application No. 12/836,797, filed on Jul. 15, 2010, now abandoned.
Application No. 12/836,797 is a continuation-in-part of application No. 12/816,149, filed on Jun. 15, 2010.
Application No. 12/816,149 is a continuation-in-part of application No. 12/816,149, filed on Jun. 15, 2010.
Application No. 12/816,149 is a continuation-in-part of application No. 12/345,289, filed on Dec. 29, 2008.
Application No. 12/816,149 is a continuation-in-part of application No. 12/238,849, filed on Sep. 26, 2008.
(60) Provisional application No. 61/225,864, filed on Jul. 15, 2009.
(60) Provisional application No. 61/187,124, filed on Jun. 15, 2009.
(60) Provisional application No. 61/187,124, filed on Jun. 15, 2009.
(60) Provisional application No. 61/016,801, filed on Dec. 26, 2007.
(60) Provisional application No. 61/290,770, filed on Dec. 29, 2009.

(51) Int. Cl. G06Q 30/00

(52) U.S. Cl. 705/14.36

(57) ABSTRACT

Improved systems, methods and apparatus are needed to provide gaming establishments within the casino, lottery and gaming industries a unified platform and middleware for the attraction, registration, engagement, delivery, management and measurement of new player acquisition through interactive mediums and channels. Acquisition of new players using such systems and methods and benefits from integration of external information on the new player. The systems and methods are configured to require entry of external information as part of delivery and/or redemption of incentives designed to attract and engage new and even existing players.

### RELATED APPLICATIONS

This application is a continuation-in-part of and claims priority under 35 U.S.C. §120 to U.S. application Ser. No. 12/836,797, entitled “SYSTEM AND METHOD FOR ENGAGING AND ACQUIRING CUSTOMERS,” filed on Jul. 15, 2010, which claims priority under 35 U.S.C. §119(e) to U.S. Provisional Application Ser. No. 61/225,864, entitled “SYSTEM AND METHOD FOR ENGAGING AND ACQUIRING CUSTOMERS,” filed on Jul. 15, 2009, which applications are incorporated herein by reference in their entirety. U.S. application Ser. No. 12/836,797 is a continuation-in-part of and claims priority under 35U.S.C. §120 to U.S. application Ser. No. 12/816,149, entitled “SYSTEM AND METHOD FOR MANAGING CONTENT DELIVERY AND MEASURING ENGAGEMENT,” filed on Jun. 15, 2010, which claims priority under 35 U.S.C. §119(e) U.S. Provisional Application Ser. No. 61/187,124, entitled “SYSTEM AND METHOD FOR MANAGING CONTENT DELIVERY AND MEASURING ENGAGEMENT,” filed on Jun. 15, 2009, each of which applications are herein incorporated by reference in their entirety. This application is also a continuation-in-part of and claims priority under 35 U.S.C. §120 to U.S. application Ser. No. 12/816,149, entitled “SYSTEM AND METHOD FOR MANAGING CONTENT DELIVERY AND MEASURING ENGAGEMENT,” filed on Jun. 15, 2010, which claims priority under 35 U.S.C. §119(e) U.S. Provisional Application Ser. No. 61/187,124, entitled “SYSTEM AND METHOD FOR MANAGING CONTENT DELIVERY AND MEASURING ENGAGEMENT,” filed on Jun. 15, 2009. U.S. application Ser. No. 12/816,149 is a continuation-in-part of, and claims priority under 35 U.S.C. §120 to U.S. patent application Ser. No. 12/345,289, entitled “SYSTEM AND METHOD FOR COLLECTING AND USING PLAYER INFORMATION,” filed on Dec. 29, 2008, which claims priority under 35 U.S.C. 119(e) to U.S. Provisional Application Ser. No. 61/016,801, entitled “SYSTEM AND METHOD FOR COLLECTING AND USING PLAYER INFORMATION,” by Mark Herrmann et al., filed Dec. 26, 2007, and 12/816,149 is also a continuation-in-part of, and claims priority under 35 U.S.C. §120 to U.S. patent application Ser. No. 12/238,849 entitled “METHOD AND APPARATUS FOR PROVIDING PLAYER INCENTIVES,” filed on Sep. 6, 2008. This application also claims priority under 35 U.S.C. §119(e) U.S. Provisional Application Ser. No. 61/290,770, entitled “SYSTEM AND METHOD FOR ENGAGING AND ACQUIRING CUSTOMERS,” filed on Dec. 29, 2009.

### FIELD OF INVENTION

The field of the invention relates generally to acquiring and engaging new customers in the gaming and lottery industry.

### BACKGROUND

Casino and lotteries are continually challenged with attracting new players and getting them to register as members of the player club. These entities are continually operating in markets where supply of the gaming product far exceeds demand. Thus, the attraction of new leads and new customers has become critical to their survival.

Today, casinos and state lotteries use player clubs, rewards, and loyalty programs to keep their players engaged and drive behavior through incentives and awards associated with membership and participation in the club. These clubs give casinos and lotteries the ability to track player participation, build a profile based on engagement with the gaming establishment, thus enabling them to use the data to fine tune their marketing approach.

Offering these club-based incentives to wider audiences could be seen as a tool to attract more new players, but is cost prohibitive to do so. It is expensive to extend benefits to non-club members. It can be recognized that for some gaming establishments, the operator may only want to understand play behavior, but cannot or does to desire to track or score specific demographic or related data, which makes targeting marketing segments much more sophisticated.

Casinos and lotteries offer aspects of their player club experience through an interactive medium, such as websites, smart phones, email marketing and SMS text messaging in an effort to reduce the total cost of engaging with their players. Gaming establishments currently spend a significant amount of money on new player acquisition marketing programs in which success of each element of the program cannot be effectively measured.

### SUMMARY

It is realized that, the gaming industry has a present need for a system, method and apparatus that not only provides the capability to attract, register, score, engage and manage new players to their player club, but also allows the operator the ability to track, measure, score, and build profile information in an acceptable way.

Improved systems, methods and apparatus are required to provide gaming establishments within the casino, lottery and gaming industries a unified platform and middleware for the attraction, registration, engagement, delivery, management and measurement of new player acquisition through interactive mediums and channels.

Furthermore, there is a present need for a system that allows the matching and merging of new player information across the systems that attract, register, engage, deliver, manage and measure new players. In most cases, these functions are accomplished by disparate systems that are focused on subsets of that entire process. Systems may be optimized to attract, register and engage new players, while other systems may be more valuable in delivering, managing and measuring those new players. Without matching and merging the new player information, the entire process is disjointed and does not provide an overall view of the new player.

According to one aspect of the present invention, a computer implemented method for providing incentives to engage and acquire new users and external relationships is provided. The method comprises the acts of establishing internal account data associated with a user record, providing at least one incentive based at least in part on the internal account data associated with the user record, wherein the at least one incentive is configured to require submission of external account information, tracking participation activity, accepting the external account information, matching the internal account data with the external account information, merging the external account information into the internal account data. According to one embodiment of the present invention, the act of matching includes identifying a potential match. According to another embodiment of the invention, the method further comprises an act of verifying a potential match. According to another embodiment of the invention, the method further comprises an act of updating a status of a user record, in response to the act of merging the external account information.

According to one embodiment of the present invention, the method further comprises an act of incorporating the tracked activity into the account data. According to another embodiment of the invention, the external account information includes lottery account information. According to another embodiment of the invention, the method further comprises an act of matching the user with at least one incentive based at least in part on the account data associated with the user, wherein the act of matching the user with at least one incentive includes acts of scoring a user based at least in part on account data, generating an incentive for the user based on the user score.

According to one aspect of the present invention, a system for engaging and acquiring new users is provided. The system comprises a registration component configured to accept and store account data associated with a user record, a matching component configured to match the user record with external account information, a merging component configured to merge external account information with internal account data, an incentive component configured to provide at least one incentive to a user based at least in part on the internal account data, wherein the incentive component is further configured to require submission of external account information, a tracking component configured to track participation, and a communication component configured to receive external account information.

According to one aspect of the present invention, a computer readable medium including instructions for performing a method for providing incentives to engage and acquire new users and external relationships is provided. The method comprises the acts of establishing internal account data associated with a user record, providing at least one incentive based at least in part on the internal account data associated with the user record, wherein the at least one incentive is configured to require submission of external account information, tracking participation activity, accepting the external account information, matching the internal account data with the external account information, merging the external account information into the internal account data. According to one embodiment of the present invention, the act of matching includes identifying a potential match. According to another embodiment of the invention, the method further comprises an act of verifying a potential match.

According to one embodiment of the present invention, the method further comprises an act of updating a status of a user record, in response to the act of merging the external account information. According to another embodiment of the invention, the method further comprises an act of incorporating the tracked activity into the account data. According to another embodiment of the invention, the external account information includes lottery account information. According to another embodiment of the invention, the method further comprises an act of matching the user with at least one incentive based at least in part on the account data associated with the user, wherein the act of matching the user with at least one incentive includes acts of scoring a user based at least in part on account data, generating an incentive for the user based on the user score.

According to one aspect a computer implemented method for engaging and acquiring new users is provided. The method comprises the acts of registering account data associated with a user, matching the user with at least one incentive based, at least in part, on the account data associated with the user, tracking activity of the user, matching the user with external account information, merging the external account information into the account data, and communicating the incentive to the user. According to one embodiment, the act of communicating the incentive to the user includes an act of targeting the communication to at least one of a plurality of users. According to one embodiment, the act of communicating occurs in response to an act of determining that the at least one of a plurality of users meets predefined criteria. According to one embodiment, the method further comprises an act of establishing a triggering event, wherein the act of communicating occurs in response to the triggering event occurring. According to one embodiment, the method further comprises an act of incorporating the tracked activity into the account data.

According to one embodiment, the external account information includes lottery account information. According to one embodiment, the activity of the user includes participation in lottery games. According to one embodiment, the act of matching the user with at least one incentive based at least in part on the account data associated with the user includes an acts of scoring a user based at least in part on account data and generating an incentive for the user based on the user score. According to one embodiment, the method further comprises an act of determining user behavior based at least in part on account data. According to one embodiment, the method further comprises an act of predicting user behavior based at least in part on account data. According to one embodiment, the method further comprises an act of requiring the user perform an action before permitting redemption of an incentive.

According one aspect a system for engaging and acquiring new users is provided. The system comprises a registration component configured to accept and store account data associated with a user, a matching component configured to match the user with external account information, a merging component configured to merge external account information with account data, an incentive component configured to match at least one incentive to the user based at least in part on the account data, a tracking component configured to track user activity, and a communication component configured to deliver communications to the user. According to one embodiment of the present invention, the communication component is further configured to target a communication to at least one of a plurality of users. According to another embodiment of the invention, the incentive component is configured to determine that the at least one of a plurality of users meets predefined criteria. According to another embodiment of the invention, the system further comprises a monitoring component configured to prompt the communication component to deliver the communication in response to a predefined event occurring. According to another embodiment of the invention, the system further comprises a monitoring component configured to track user activity. According to another embodiment of the invention, the merging component is further configured to merge the tracked user activity into the account data. According to one embodiment, the external account information includes lottery account information. According to one embodiment of the present invention, the merging component is further configured to query external account information.

According one aspect a computer readable medium is provided. The computer readable medium includes instructions for performing a method of engaging and acquiring new users. The method comprises the acts of registering account data associated with a user, matching the user with external account information, merging the external account information into the account data, and matching the user with at least one incentive based at least in part on the account data associated with the user tracking activity of the user, and communicating the incentive to the user. According to one embodiment, the act of communicating the incentive to the user includes an act of targeting the communication to at least one of a plurality of users. According to one embodiment, the act of communicating occurs in response to an act of determining that the at least one of a plurality of users meets predefined criteria. According to one embodiment, the method further comprises an act of establishing a triggering event, wherein the act of communicating occurs in response to the triggering event occurring. According to one embodiment, the method further comprises an act of incorporating the tracked activity into the account data.

According to one embodiment, the external account information includes lottery account information. According to one embodiment, the activity of the user includes participation in lottery games. According to one embodiment, the act of matching the user with at least one incentive based at least in part on the account data associated with the user includes an acts of scoring a user based at least in part on account data and generating an incentive for the user based on the user score. According to one embodiment, the method further comprises an act of determining user behavior based at least in part on account data. According to one embodiment, the method further comprises an act of predicting user behavior based at least in part on account data. According to one embodiment, the method further comprises an act of requiring the user perform an action before permitting redemption of an incentive.

According to one aspect of the present invention, a computer implemented method for providing incentives to engage and acquire new users and external relationships is provided. The method comprises acts of establishing, on a computer system, internal account data associated with a user record, accessing, by the computer system, at least one incentive, identifying, by the computer system, at least one external account target based at least in part on the internal account data associated with the user record, providing, over a communication network, the at least one incentive to at least one user, wherein the at least one incentive is configured to require activation of the at least one external account target, tracking, by the computer system, participation activity by the at least one user, accepting, over the communication network, external account information associated with the at least one external account target, wherein the act of accepting includes permitting the at least one user to redeem the at least one incentive in response to activation of the at least one external account target, matching, by the computer system, the internal account data with the external account information, and merging, by the computer system, the external account information into the internal account data. According to one embodiment of the present invention, the act of matching includes identifying a potential match between the internal account data associated with a user record and the external account information. According to another embodiment of the invention, the method further comprises an act of verifying a potential match. According to another embodiment of the invention, the act of verifying the potential match, includes acts of submitting, automatically, by the computer system, authentication information obtained from the at least one user.

According to one embodiment of the present invention, the participation activity includes at least one of redemption of the at least one incentive, creation of an external account, activation of an external account, user activity associated with the external account, and the act of tracking participation activity includes at least one of accessing at least one external account automatically and receiving participation activity from an external account system associated with the external account information. According to another embodiment of the invention, the method further comprises an act of updating a status of a user record, in response to the act of merging the external account information. According to another embodiment of the invention, the method further comprises an act of incorporating the tracked activity into the account data. According to another embodiment of the invention, the external account information includes lottery account information. According to another embodiment of the invention, the method further comprises an act of matching the user with at least one incentive based at least in part on the account data associated with the user, wherein the act of matching the user with at least one incentive includes acts of scoring a user based at least in part on account data, generating an incentive for the user based on the user score. According to another embodiment of the invention, the internal account data is hosted by a an online gaming system connected to the at least one external account target by a communication network, and wherein the at least one external account target comprises at least one of a player club account managed by a gambling establishment and a membership account provided by a lottery retailer. According to another embodiment of the invention, the method further comprises an act of associating a pre-generated external account to the at least one incentive offer.

According to one aspect of the present invention, a system including at least one processor operatively connected to a memory for engaging and acquiring new users is provided. The system comprises a registration component configured to accept and store account data associated with a user record, a matching component configured to match the user record with external account information, a merging component configured to merge external account information with internal account data, an incentive component configured to identify at least one external account target provide at least one incentive to a user based at least in part on the internal account data, require activation of the at least one external account target, a tracking component configured to track participation by the user, and a communication component configured to receive external account information communicated by an external account provider. According to one embodiment of the present invention, the system further comprises a redemption component configured to validate the received external account information. According to one embodiment of the present invention, the system is further configured to identify a potential match between the internal account data associated with a user record and the external account information. According to another embodiment of the invention, the system is further configured to verify a potential match. According to another embodiment of the invention, the system is further configured to submit, automatically, authentication information obtained from the at least one user.

According to one embodiment of the present invention, the participation by the user includes at least one of redemption of the at least one incentive, creation of an external account, activation of an external account, user activity associated with the external account, and the act of tracking participation activity includes at least one of accessing at least one external account automatically and receiving participation activity from an external account system associated with the external account information. According to another embodiment of the invention, the system is further configured to update a status of a user record, in response to the act of merging the external account information. According to another embodiment of the invention, the system is further configured to incorporate the tracked activity into the account data. According to another embodiment of the invention, the external account information includes lottery account information. According to another embodiment of the invention, the system is further configured to match the user with at least one incentive based at least in part on the account data associated with the user, wherein the system is further configured to score a user based at least in part on account data, and generate an incentive for the user based on the user score. According to another embodiment of the invention, the internal account data is hosted by a an online gaming system connected to the at least one external account target by a communication network, and wherein the at least one external account target comprises at least one of a player club account managed by a gambling establishment and a membership account provided by a lottery retailer. According to another embodiment of the invention, the system is further configured to associate a pre-generated external account to the at least one incentive offer.

According to one aspect of the present invention, a non-transitory computer readable medium including instructions for performing a method for providing incentives to engage and acquire new users and external relationships, the method comprising the acts of establishing internal account data associated with a user record, accessing at least one incentive, identifying at least one external account target based at least in part on the internal account data associated with the user record, providing the at least one incentive to at least one user, wherein the at least one incentive is configured to require activation of the at least one external account target, tracking participation activity by the at least one user, accepting external account information associated with the at least one external account target, wherein the act of accepting includes permitting the at least one user to redeem the at least one incentive in response to activation of the at least one external account target, matching the internal account data with the external account information; and merging the external account information into the internal account data. According to one embodiment of the present invention, the act of matching includes identifying a potential match between the internal account data associated with a user record and the external account information. According to another embodiment of the invention, the method further comprises an act of verifying a potential match. According to another embodiment of the invention, the computer-readable medium further comprises an act of verifying a potential match, wherein the act of verifying includes an act of submitting, automatically, by the computer system, authentication information obtained from the at least one user to the external system.

According to one embodiment of the present invention, the participation activity includes at least one of redemption of the at least one incentive, creation of an external account, activation of an external account, user activity associated with the external account, and the act of tracking participation activity includes at least one of accessing at least one external account automatically and receiving participation activity from an external account system associated with the external account information. According to another embodiment of the invention, the external account information includes lottery account information. According to another embodiment of the invention, the computer-readable medium further comprises an act of matching the user with at least one incentive based at least in part on the account data associated with the user, wherein the act of matching the user with at least one incentive includes acts of scoring a user based at least in part on account data, generating an incentive for the user based on the user score. According to another embodiment of the invention, the internal account data is hosted by a an online gaming system connected to the at least one external account target by a communication network, and wherein the at least one external account target comprises at least one of a player club account managed by a gambling establishment and a membership account provided by a lottery retailer. According to another embodiment of the invention, the method further comprises an act of associating a pre-generated external account to the at least one incentive offer.

### BRIEF DESCRIPTION OF THE DRAWINGS

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by references signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 is a screen capture of an example user interface, according to aspects of the invention;

FIG. 2 is a screen capture of an example user interface, according to aspects of the invention;

FIG. 3 is a screen capture of an example user interface, according to aspects of the invention;

FIG. 4 is a screen capture of an example user interface, according to aspects of the invention;

FIG. 5 is a screen capture of an example user interface, according to aspects of the invention;

FIG. 6 is a screen capture of an example user interface, according to aspects of the invention;

FIG. 7 is a screen capture of an example user interface, according to aspects of the invention;

FIG. 8 is a screen capture of an example user interface, according to aspects of the invention;

FIG. 9 is an example process flow for registering a new player and merging matched accounts, according to aspects of the invention;

FIG. 10 is an example process flow for player engagement, according to aspects of the invention;

FIG. 11 is a block diagram of an example system for engaging and acquiring new users, according to aspects of the invention;

FIG. 12 is a block diagram of an example system for engaging and acquiring new users, according to aspects of the invention;

FIG. 13 is a block diagram of an example system for engaging and acquiring new users, according to aspects of the invention;

FIG. 14 is a block diagram of an example system for engaging and acquiring new customers, according to aspects of the invention;

FIG. 15 is a block diagram of an example system for engaging and acquiring new customers, according to aspects of the invention; and

FIG. 16 is an example process flow for establishing internal account data and merging external account information, according to aspects of the invention.

### DETAILED DESCRIPTION

According to one aspect of this invention, a player club (lottery or casino), profile analysis, behavioral targeting and tracked player engagement is combined with one or more systems, methods and apparatus to provide gaming establishments within the casino, lottery and gaming industries a unified platform and middleware for the attraction, registration, scoring, engagement, delivery, management and measurement of new player acquisition through interactive mediums and channels. These systems, methods and apparatus provide operators with a unique, unified and efficient approach to new player acquisition, engagement and performance tracking through an interactive mediums and channels.

### Registration

In one aspect of this invention, a system is provided for the registration of account data. Upon creation, a unique identifier is associated with the account. That information is then stored on a computer readable medium, in memory, on disk or in a database, for example.

In one embodiment, the registration system provides an input mechanism that allows a user the ability to provide data relevant to the account, such as but not limited to username, password, first name, last name, date of birth, gender, address, zip code, phone number, cell phone number, and email address. Upon submission to the registration system, that data is stored in memory, on disk or in a database. A unique identifier is created and associated with the account. A mechanism is provided that allows a user of the registration system the ability to fetch the account data from disk using that unique identifier, or other data elements related to the account.

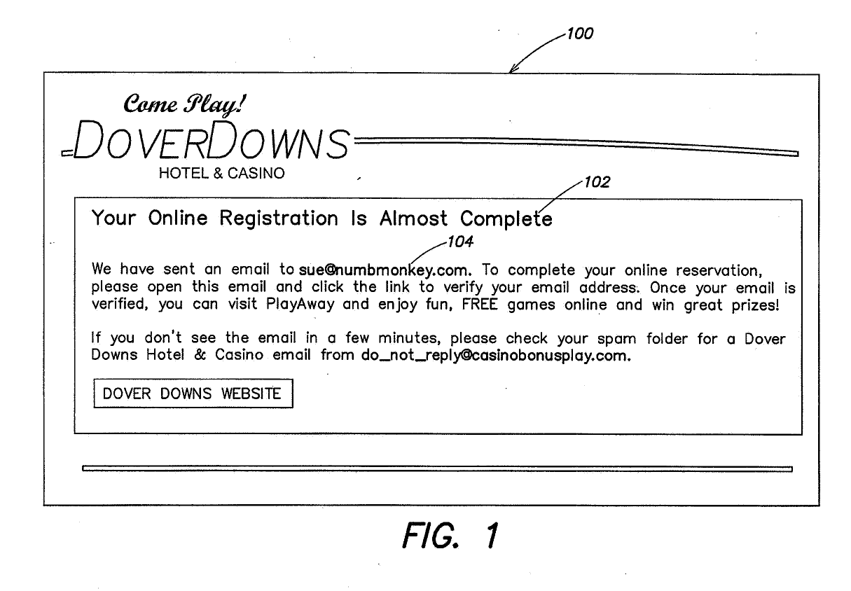

Shown in FIG. 1 is an example user interface display on a host computer system accessed by a new registrant/user 100. User interface 100 is configured to provide the new registrant information on registration status at 102. Further the user interface can be configured to confirm user entered information at 104. In some embodiments, additional actions can be required to complete registration. For example user interface 100 can indicate to the new registrant that confirmation is required. The confirmation (not shown) can be for example a hyperlink delivered to an external account. The hyperlink can be configured and/or associated with the new registrant's unique identifier. Clicking on the hyperlink can trigger communication between the external account, as shown in FIG. 1, an external e-mail account, and the registration system. The communication can be configured to permit merging of the external account information and the registration account. In some embodiments, merging of account information permits the registrant to access the registration account using “merged” account information, including for example, the registrant's e-mail address and password.

In one aspect of this invention, a system is provided for the registration of account data and that account data can be linked to an account external to the system, using one or many external identifiers.

For example, the registration system provides an input mechanism as described above, but also can ask for external account data, such as but not limited to a username for an external account, password for an external account, an access code or a unique identifier. This external account data is then linked to this account data for later use. This enables a new player who is registering with the registration system for the first time the ability, for instance, to link their Master Card, Visa or other credit card with the registration system for future payment transactions that may occur. In some embodiments, an internal registration system can be configured to access external accounts automatically. The internal registration system can validate user provided information by successfully accessing the external account. The internal registration system can be further configured to provide information regarding registered external accounts in a display associated with the internal registration system. In one example, a user interface of the internal registration system can provide balance information, purchase activity, etc. associated with the external account.

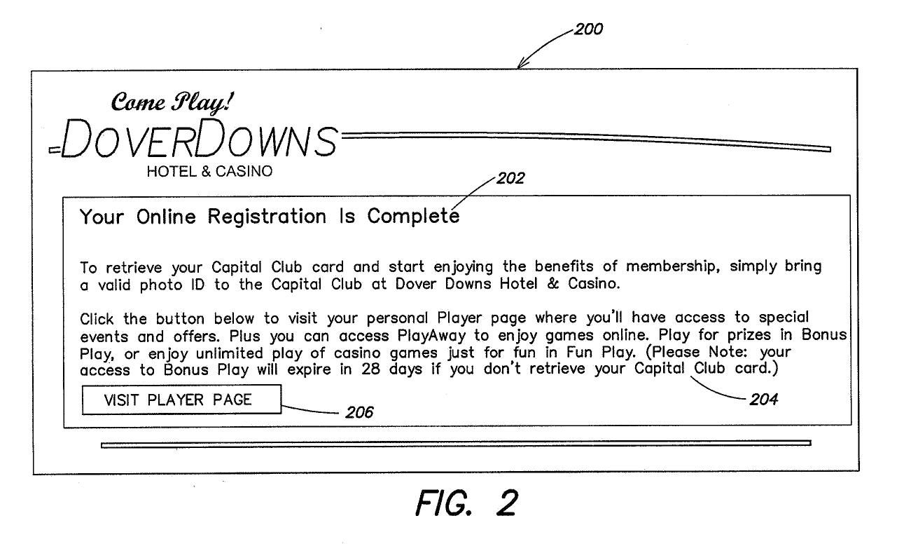

Shown in FIG. 2, is an example user interface 200. Interface 200 can be displayed in response to a user confirming registration information provided during a registration process. The confirmation information can include for example, browser executable instructions that cause a browser program to communicate with a new player registration system. The browser executable instruction can be configured to open a web page for the registration system. User interface 200 can be displayed in conventional browser programs executing on a host computer, for example. Host computers can include home computers, laptops, PDA, cell phones, etc. Upon confirmation, registration status can be updated to indicate registration is complete at 202.

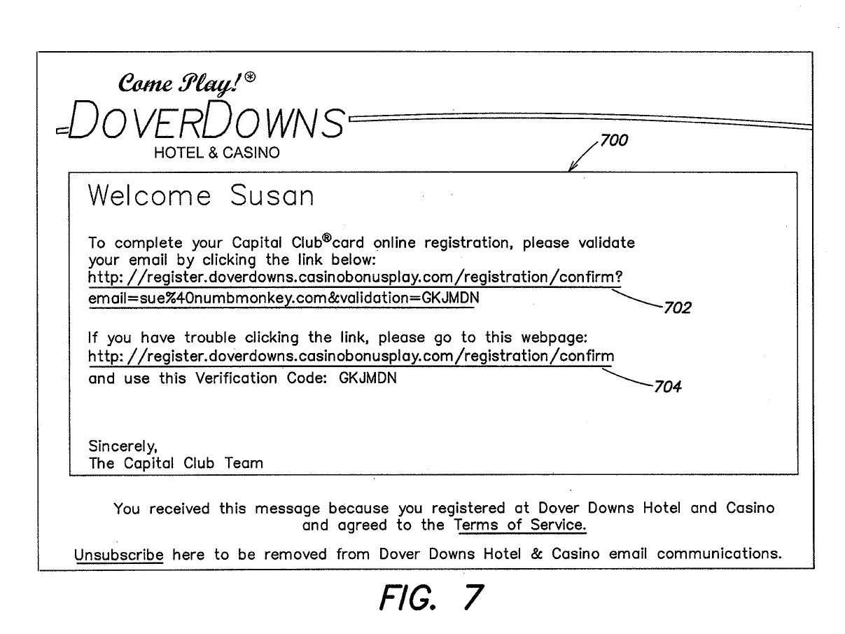

An example confirmation display 700 is illustrated in FIG. 7. The example confirmation display can be presented to an end user through a graphical user interface on a host computer system. At 702 displayed is a hypertext link that causes a conventional browser program to access the displayed address, providing the encoded information automatically to the server hosting the addressed page. In other examples, other executable instruction can be embedded in a confirmation message that permits delivery of confirmation information to a registration system. Shown at 704 is an optional access channel Optional access channel 704 includes an address for a web connected process on a server associated with the registration system. By accessing the Internet address, the user/registrant is able to enter confirmation information for completing a registration process.

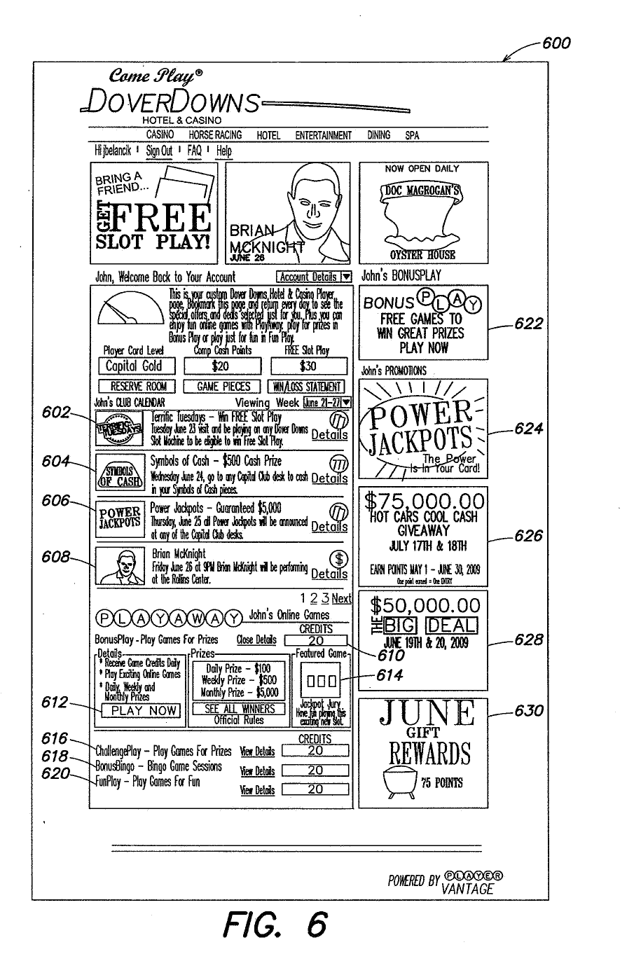

In some embodiments, user accounts can also be configured with an engagement status. Engagement status can be configured to prompt users to perform required actions. For example, at 204, FIG. 2, the user interface 200 indicates that access to the bonus play will expire in 28 days unless the Capital Club card is physically retrieved. Once a user retrieves the Capital Club card, engagement status can be configured to change to active. It is realized that providing multiple incentives to participate and even limiting access can induce a user to perform actions that build engagement patterns for particular users. At 206 the user can select a link to their personal page, which can include additional offers and additional information on engagement status. Further interface 200, can be configured to automatically direct the user to their account information, including for example user interface 600, FIG. 6, described in greater detail below.

As another example, a lottery player loyalty system or a casino player management system may be the ultimate canonical source of account data related to this player. An external unique identifier can be stored and associated with the new account data so that future reference to a players account in these external systems can be achieved. In some settings the merging of accounts can be directed by a registration system and include communicating the registration account information to an external account management system. Thus, the external account system can receive information and become the merged source of information on the user.

In another aspect of this invention, registration and/or engagement systems may serve as central management of player accounts for a state run lottery or state run gaming authority. The systems can also serve as a player loyalty and tracking system as well.

For example, a lottery may not have a system in place to manage player accounts. It can be appreciated that this system, as described herein, can provide account registration features as well as account management features for this system.

In another aspect of this invention, a registration system and/or an engagement system can use account data that is provided during the registration process to determine games, offers, rewards and other content that can be delivered to the player as an incentive for registration with the system. Predictive analytics can be used to measure player potential, score the individual, and rewards and other content can be delivered based on that score.

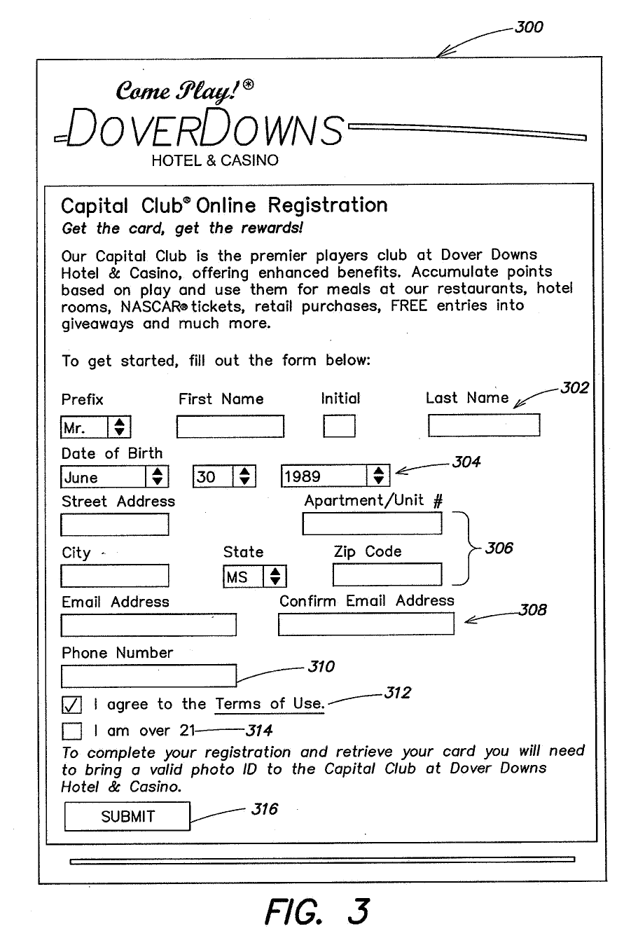

For example, a new registrant may interact with a registration system through a state lottery website. The new registrant registers with the system by clicking a registration link on the state lottery home page. FIG. 3 illustrates an example user interface 300 that can be displayed in response to user selection of a registration link. A user is prompted to submit user information: for example, name 302, date of birth 304, address 306, e-mail 308, and phone number 310. In some settings, a user will have to confirm they agree with the terms of use 312 to proceed with registration. In some embodiments, the system can be configured to calculate age based of date of birth. In some examples, a user can be required to affirmatively state that they are at least 21 years of age 314. Selection of 316, submit, can be configured to complete the registration process. In some settings, registration can also include a required confirmation of submitted information and/or other required actions to complete the registration.

In one embodiment, once the registration process is complete, data related to the player is fed through scoring functions, which can include but is not limited to, statistical models, predictive analysis, and regression tests, to produce a score that can then determine incentives to be awarded to the player for their registration with the system. Various methods and systems for scoring users/players are disclosed in co-pending U.S. patent application Ser. No. 12/345,289, entitled “SYSTEM AND METHOD FOR COLLECTING AND USING PLAYER INFORMATION,” filed Dec. 29, 2008, on which and/or in conjunction with various aspects of the present invention may be practiced.

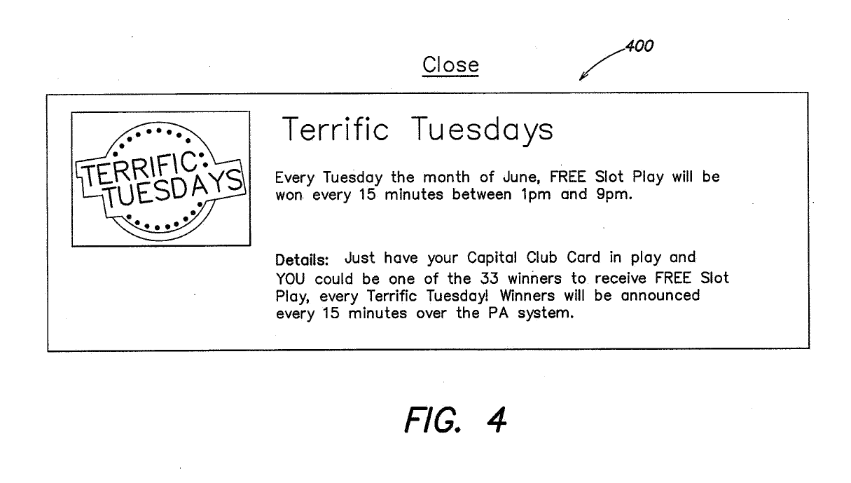

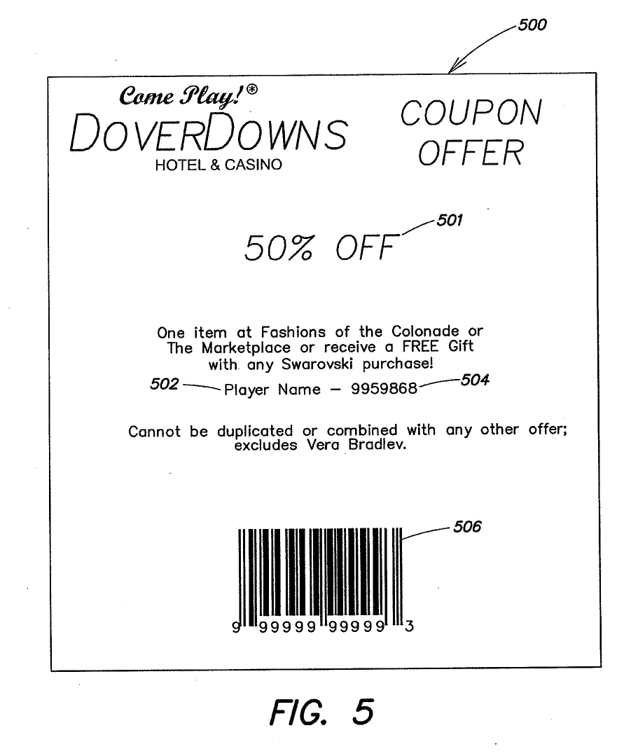

In one aspect of this invention, activities performed by registered and identified users of the system are tracked and then used to determine awards and content to be offered to the user of the system. FIGS. 4 and 5 illustrate example awards that can be presented to system users. User interface 400, can be configured to be displayed an opportunity uniquely tailored to a registered and identified player. For example, a user profile may include information that the majority of play by a particular player occurs on a given day of the week, triggering the system to deliver a tailored opportunity at 400. Other awards can be tailored to a given player based on information retrieved from an external account. For example, a player's visa card purchases can indicate affinity for fashion and accessories, triggering the system to deliver a tailored opportunity through a user interface at 500, FIG. 5. User interface 500, can also be configured to provide incentives to complete registration and further to trigger merging of external accounts. As shown, interface 500 displays an offer 501, which includes at 502 player name and a unique identifier for the player at 504. In some settings this information (e.g. 502 and/or 504) can be entered by hand at a point of sale location. In other embodiments, a bar code can encode information at 506. In other embodiments, coupons can be generated with bar codes, with or without further player information 502 and/or 504. Further, in one example, the bar code 506 can be omitted where player information is printed at 502 and/or 504. Scanning of the coupon at the point of sale location can trigger a change in status. In one example, status can be tracked as an engagement status. Further scanning of the bar code can permit association of an external account with the registration account, for example, a visa card used during the purchase at the point of sale location, and/or other information associated with the sale at the point of sale location.

According to one embodiment, tracked activities performed by registered and identified users are used to adjust calculated scores, and in some embodiments to predict future user behavior. Additionally in some examples, activities such as games played, time spent on a website, visits to particular internet content, can be used to measure and score preference data that can then be used to determine rewards and content that can be offered to the player.

In another aspect of this invention, registration of an account is done via a paper form that is filled out by a new registrant. That paper form can then be:
a. Entered into a registration system by the operator using the mechanism described above
b. Scanned at the point of sale by a device, analyzed, potentially cleansed and provided to the operator for review.
c. Scanned at the point of sale by a device, analyzed, potentially cleansed and then automatically reviewed and automatically entered into a registration system.

For example, a new player at a retail lottery or casino gaming location fills out a paper form by hand. That paper form is then either given to the retailer and then mailed to the operator for input into the system, or entered into a scanning device at the point of sale. That scanning device can be connected to a WAN, such as the public Internet, or to a LAN, such as a private network. In one case, data related to the scanned form is then transferred from the scanning device (or associated device) to the system, either in batch or in real time. The operator is then notified that the scan exists and is then provided the tools to accept, deny, initiate automatic analysis and account creation or enter the scanned application into the system. In another case, the scanned data is transferred to the system form the scanning device as described above. When the system receives the scanned form it then associates that data to a unique identifier and then stores that data in memory, on disk or in a database. The system then applies an analysis process to the stored data to provide one, all or a combination of the following functions:
a. Convert hand written text into a computer readable format
b. Scan hand written data for inaccuracies and errors
c. Report inaccuracies and errors by storing those errors in the system and associating them to the account
d. Applying the converted hand written and now human readable data to the process of creating an account

In another aspect of this invention, only partial data may be provided to the system. The system can then take that partial data and use external data sets, systems and services to fill in the rest of the require account data.

For example, a user may only provide their cell phone number during the account registration process. That cell phone number is linked to an account record for the registrant's phone provider. An interface is provided by which the system can query a data set, system or service to extract the account data related to the phone number and store that account data in the system record.

In another example, a user may only provide their cell phone number to a registration and/or redemption system in the form of a TXT message sent as response to an incentive or offer. The user's phone number is linked to an account record for the registrant's phone provider. An interface is provided by which the system can query a data set, system or service to extract the account data related to the phone number and sort that account data in the system record. In an alternative embodiment, the phone number may be the only account data associated with the player activity on the system until the player volunteers additional data to associate with the account record, submitted either through written record or electronic from, such as a registration form on a website.

In one aspect of this invention, a system and interface is provided that allows for the management of account data. Such management systems can be part of a registration system. Further management systems can be used in conjunction with a registration system. In some embodiments, the management system can incorporate the functions associated with registration, content delivery, and engagement of new registrants.

In one example, a ‘GUI’ or graphical user interface is provided that allows the operator to create, edit, analyze or remove account data.

In one aspect of this invention, management of account data may be restricted to particular users. Certain rights and privileges may be applied to particular accounts in the system to allow for roles related to data access and management.

For example, an operator may want to give particular lottery retailers, or all lottery retailers, the ability to create accounts on site, using the ‘GUI’ or graphical user interface. They also may want to give particular ‘super’ retailers the ability to perform functions that other retailers cannot, such as crediting an account, changing contact information, or performing other retail-level customer service issues.

As another example, a casino gaming facility may want only particular members of their floor staff the ability to read account data, but only allow a manager the ability to credit an account, change contact information or perform other floor-level customer service functions.

Registration can occur in conjunction with the delivery and/or redemption of promotional offers, some example promotional offers and some methods of delivering them are described in for example, co-pending U.S. patent application Ser. No. 11/841,754 entitled “METHOD AND APPARATUS FOR PROVIDING PLAYER INCENTIVES,” filed Aug. 20, 2007, published as U.S. Patent Application Publication Number 2008-0146346 A1 on Jun. 19, 2008 with the same title, incorporated herein by reference. Additionally registration can occurs in conjunction with player tracking, as described in for example, U.S. patent application Ser. No. 12/345,289 entitled “SYSTEM AND METHOD FOR COLLECTING AND USING PLAYER INFORMATION,” filed Dec. 29, 2008, published as U.S. Patent Application Publication Number US 2009-0176578 A1 on Jul. 9, 2009 with the same title, incorporated herein by reference.

### Matching Accounts

In one aspect of this invention, a new player registers for an account through an interactive medium, such as a casino or lottery's website. Once that account registration is complete, an incentive is offered to the new registrant, such as an online game for the chance to reveal prizes and incentives, an offer, or a coupon.

For example, the new registrant may be offered the chance to play a selection of online games that provide the opportunity for the user to reveal prizes and awards. The user plays through a particular game and reveals a $100 ‘free play’ coupon for redemption at a casino gaming facility or a state lottery retail location. The user is then given the ability to print that coupon and use it to redeem their $100 ‘free play’ award.

The registration system can present a web page to the user, including incentive offers for which the user qualifies. An example web page is illustrated in FIG. 6. At 600 shown is a screen capture of a player account page. The player account page 600, includes information on incentive offers available 602-606 and/or engagement opportunities tailored to the player's profile 608. Registration can include award of player credits that can be redeemed by the player in online games. A credit balance can be shown to the player at 610. Available online game opportunities can be displayed on the player account page at 612. The display can include a feature game 614, displayed based on determined player affinity. Alternatively, the feature game can be displayed based on a game selected by an operator independent of individual players and/or affinities. Players can be provided a plurality of game options to select from at 616-620. Also promotions 622-630 can be displayed on the player account page 600. The displayed promotions can be tailored to the player's profile and/or determined affinities. Alternatively, the promotions 622-630 can be displayed based on a calculated player score used to qualify the player.

In one aspect of this invention, a system uses the bar code associated with a coupon to identify a registered user's account. When the bar code is scanned, the system records the indicia of that event and associates that event with the coupon and the user account.

For example, when a user receives an award that is associated with a coupon, a unique identifier is generated, associated with the user account and encoded in full, or along with other data, as a bar code on the coupon itself. On example coupon is displayed electronically in user interface 500, FIG. 5. When the coupon is redeemed at a casino gaming establishment or a lottery retail location, the system decodes and recognizes the unique identifier and marks the coupon as redeemed.

In another aspect of this invention, a system can be configured to require a set of actions to occur before it recognizes the registered account to be in a particular state.

For example, one method for tracking new player engagement includes acts of requiring a user fill out a registration form, participate in an interactive online game, to reveal a prize, accept an electronic coupon, print that coupon, take that coupon to a gaming establishment or a lottery retailer and have the coupon's bar code scanned and validated before the user's account is set to an ‘active’ state.

In another aspect of this invention, user accounts that have not been placed in the ‘active’ state may only be allowed to interact with a system for a configured amount of time.

For example, an operator can configure the system to allow only non-active accounts the ability to interact for a total of 30 days.

In another aspect of this invention, user accounts that have not been placed in the ‘active’ state may only be given a configured amount of time to complete one, all or a group of actions required to set the account to a particular state.

For example, 10 hours to finish filling out a registration form, 1 day for participating in an interactive online game, 20 minutes to reveal a prize, 15 days to accept, print and redeem a coupon at a gaming establishment or lottery retailer may be the steps required by the system before the user's account is set to an ‘active’ state.

In another aspect of this invention, user accounts that have not been placed in the ‘active’ state may be given an indefinite amount of time to complete one, all or a group of actions required by the system to set the account to a particular state.

For example, a player has an indefinite amount of time to complete account registration, print a coupon, visit the gaming establishment or lottery retailer, register for an external account and redeem the coupon.

In another aspect of this invention, redeeming a coupon at the gaming establishment or lottery point of sale also requires the creation of an account external to the system. As an example, the account external to the system can be an account on a casino tracking system. Once this account is created, the coupon is scanned and the account is set to a ‘redeemed’ state.

According to one embodiment, at this stage it can be beneficial for the two accounts—the account created through the interactive medium and the external account—to be matched and merged. This allows both systems to treat the account in a single, unified approach while sharing any additional information that is captured or generated regarding that account.

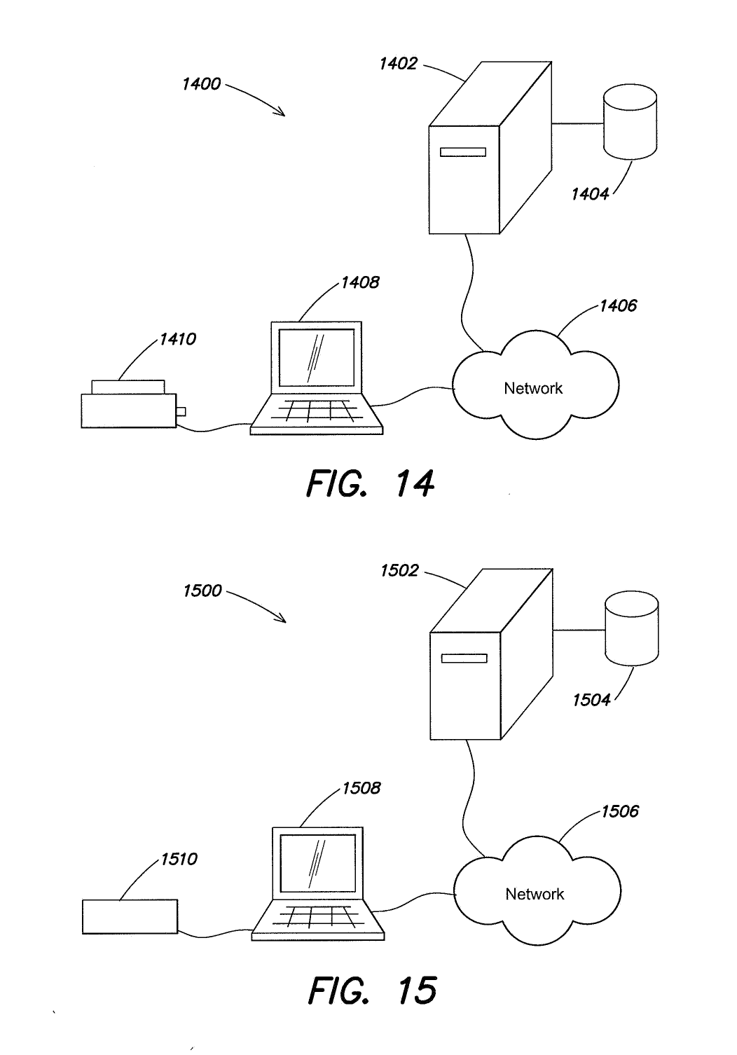

In one aspect of this invention, the matching and merging process may be accomplished over a data connection between an internal system and the external account system. A block diagram of an example internal system is shown in FIG. 14, which can be operatively connected to an external account system. A block diagram of an example external account system is shown in FIG. 15. The connection between internal and external systems can be a real-time connection, a near-real-time connection or a manual push/pull connection. In addition, the registrant or representative of the gaming facility of lottery retail location may be required to take certain actions to provide the data manually in order for the systems to match and merge the accounts.

In one aspect of the invention, the user is then required to interact with the internal system so that the system can reconcile or ‘merge’ the system account with the external system account and set the user account to an ‘active’ state. The internal system can be configured to require either a connection to the external system or for the external system to provide (push or pull process) the account information. The internal system can also be configured to accept information from a player and automatically merge external account information with the player's internal system records. In one example, the user interaction is performed as part of a redemption process. The redemption process can include requiring the user to enter internal account information, and internal account authentication information, and confirm for example the creation of an external account by providing the external account number in whatever format. The process may also include submission of authentication information for the external account. The external account information can be used during a merge process.

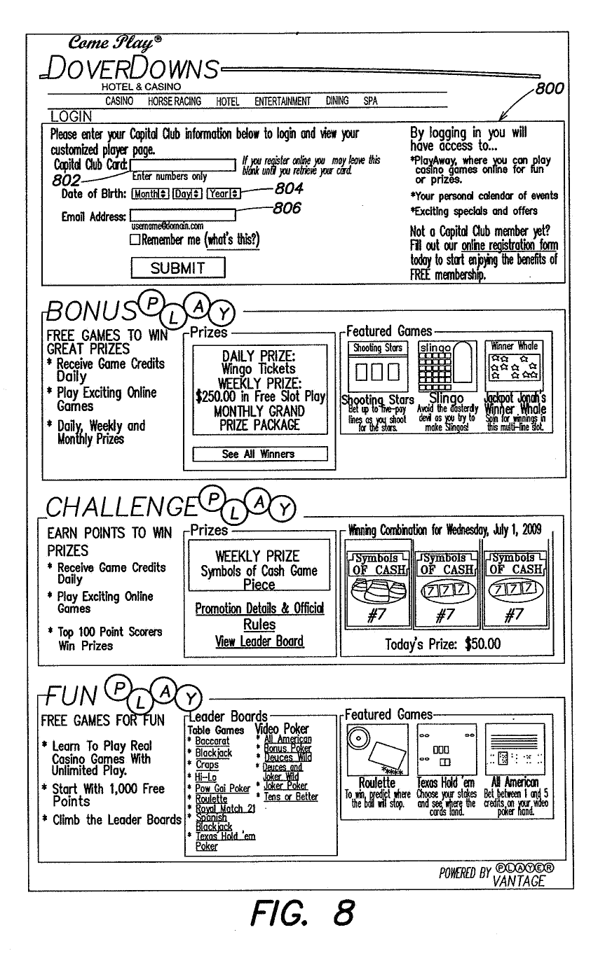

An example interface is shown in FIG. 8. Interface 800 can be displayed as a web page within a browser program executing on a computer system. Interface 800 permits a user to enter external account information at 802, and/or other identifying information, for example, date of birth at 804 and/or e-mail address at 806, to associate the external account information with the system account information. Alternatively, interface 800 can be used to establish a system account that can then be merged with external accounts.

For example, a registrant may scan a coupon at a gaming establishment or lottery retailer. That scan may also require that they register for a loyalty club. At some point after they complete the loyalty club registration, the registrant returns to the gaming establishment or lottery retailer's website and logs into the system using their account credentials as well as an identifier from their external account, such as a loyalty account number. Once they log in using these credentials, the system uses the local account credentials and the external account credentials to assert that the user has completed all step of the registration process, using either connectivity to the external account management system, or using data transferred to the system by the external account.

In one embodiment, the registrant provides email address plus date of birth for the internal system and then account identifier (e.g. playercard) and date of birth from the external system. The registrant can be required to enter all three parameters for verification: email address, date of birth and external account identifier. If the email address plus date of birth matches an existing account record in the internal system, while the external account identifier and date of birth match a record from the external system, then the two account records are then ‘merged’ to create one account record that stores locally unique identifiers for the record in the external system. At this point in time, the user will then be able to log into the website using the external account credentials as well as the local account credentials. It can be appreciated that the system may ‘merge’ this account with one, many, or a combination of external account systems. The merged account can be stored on a separate system, or can be maintained on the internal system.

In another aspect of this invention, the external system provides the same unique identifier (e.g. email address) or unique combination of identifiers (e.g. email address and date of birth) used by the internal system along with the external account identifier (e.g. playercard) automatically. The external system can also be configured to deliver this information as part of an audit process and can be configured to deliver information on a real time basis. An automated process can then take each record and update the internal system to append the external account identifier to a matching internal identifier or combination of identifiers.

In one aspect of this invention, matching and merging of accounts can happen in real time.

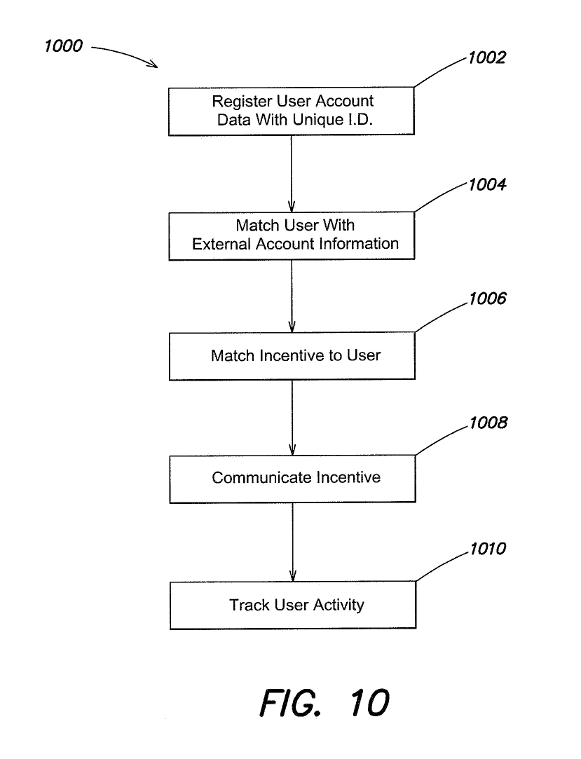

For example, a system can be connected to the external account system through a WAN or a LAN. The system requests account data from the external account system in real time in order to match and then merge system records. Shown in FIG. 10, is an example process for player engagement. Example process 1000 beings at 1002 with registering a user account, and the user account data with a unique identifier. Registration information provided by the user permits the system to match the user with external account information hosted on an external computer system at 1004. For example, a user can be prompted to enter a user name and password for an external account as part of registration. The system can be configured to poll the external account for any information on the user. After the user's information has been merged, the system can be configured to match incentives to the user based on merged data. At 1006, the system matches incentives to the user. According to process 1000, the matching can occur based on the initial registration data, and/or on data merged with the registration data. In some settings the match incentive is configured to prompt the user to provide additional information to permit matching of the user with external account information.

The incentive matched to the user is communicated at 1008. Redemption of the incentive can be tracked for any given user registered with the system at 1010. Tracking at 1010 can include tracking of activity associated with the incentive, and further can include tracking of external account information/activity. For example, the incentive can be a coupon providing discount at retail establishments. Any activity at the retail establishment, for example, purchase activity can be associated with the incentive (e.g. by scanned bar code) and tracked. Further, unique identifiers can be used with given incentives to permit and/or require registration, and subsequent merging of external accounts. In another aspect of this invention, matching and merging of accounts can happen in close-to-real-time.

For example, the matching and merging of accounts can happen in a batch process. At configured time intervals, a registration system can be configured to connect to the external account system through a WAN or LAN. The system requests account data from the external account system in real time in order to match and then merge system records.

In another aspect of this invention, matching and merging of accounts can happen at the time of coupon redemption.

For example, an interface and module of a registration system can be built into the external account management system so that the external account management system can scan and redeem the coupon through the context of the user's external account. The system is connected to the module running in the external account system through a WAN or a LAN and transmits required data for merging the accounts once the scan occurs.

In another aspect of this invention, matching and merging of accounts can happen ‘by hand’ through an interface provided to the operator.

For example, a clerk at a gaming establishment or lottery retailer is provided an interface, ‘GUI’ or graphical user interface to the system. When the external account registration is complete, the clerk is required to enter the external account identifier into the interface prior to the scan of the coupon, either using a keyboard or by swiping the new player card through a magnetic reader. When the coupon is scanned, the external account identifier that was entered into the interface is then transmitted through a WAN or LAN to the system and the account merge occurs.

In another aspect of this invention, the internal system can be provided a group of external system identifiers (e.g. playercards) that are not associated with any registrant. At the time of registration, the internal system could then assign an external system identifier from this list. At redemption time, the coupon would contain all the internal registration information, including the external system identifier. Upon successful redemption, the external system would be updated to assign the registration data to that external system identifier.

In another aspect of this invention, matching and merging of accounts can happen by the user interacting with a kiosk, ‘GUI’ or graphical user display on property or at the retail location.

For example, the user could register for an account with the external system at a kiosk or gaming machine and scan their coupon at that device. The registration system can be configured to connect to the kiosk or gaming machine through a WAN or a LAN and transmits required data for merging the accounts once the scan occurs.

As another example, a player signs up on property for an external account, such as a loyalty or player club account. The player receives a new player card with their unique identifier encoded on the bar code. The player then swipes the new card in a magnetic card reader attached to a kiosk or gaming device, uses a touch screen, mouse or keypad to select an option to confirm account credentials and enters account credential such as email address and then a password and pin. The system can be connected to the kiosk or gaming machine through a WAN or a LAN and transmits required data for merging the accounts once the user input is complete.

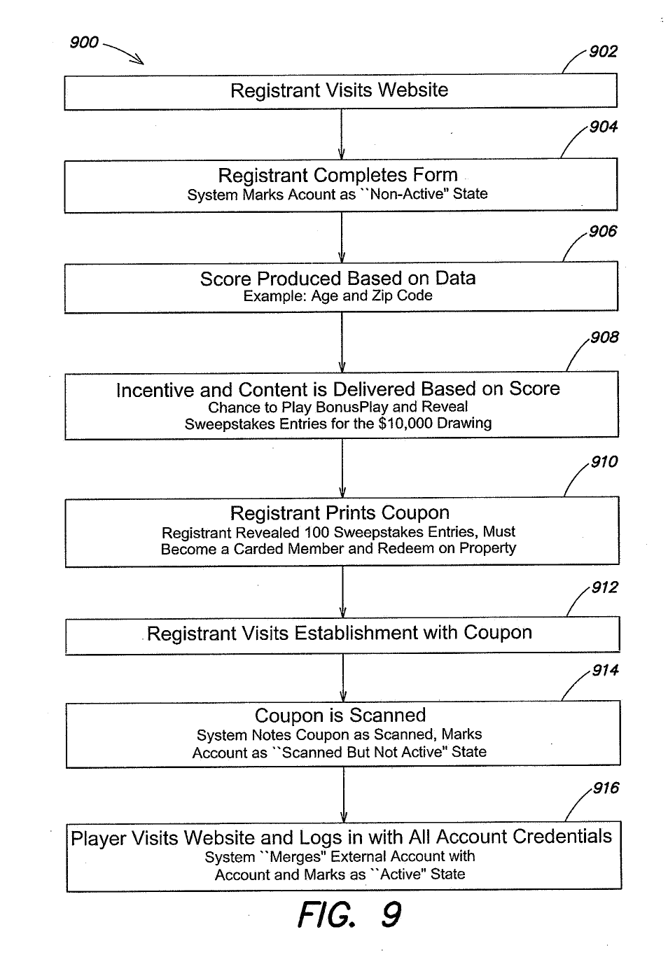

FIG. 9 illustrates an example process 900 for registering a new player and merging matched accounts. Process 900 can begin with a new player/registrant accessing a web site on a host computer system at 902. The registrant accesses a user interface displayed on a browser program executing on the host computer system. The interface is configured to prompt the registrant complete a form displayed in the interface at 904. In one embodiment, the registrant can be scored at 906, based on the submitted information. For example, the zip code entered by the registrant can be used to develop a player scores. In another example, the registrant's age can be used to develop a player score. In some embodiments, the information provided by the registrant can be evaluated to determine a player score. An example registration and/or engagement system can be configured to provide incentives and content to a registrant based on the calculated score. For example, certain offers and content can be configured to require a minimum score to qualify. At 908, incentives and content are delivered based on the player score calculated for the registrant. For example, an incentive can include an opportunity to be awarded 100 sweepstakes entries, if the registrant becomes a card carrying member of a player's club and redeems the coupon on the property hosting the player's club. For example, the inventive can require the registrant sign up for a casino player's club and redeem the coupon at that casino.

In one embodiment, incentives and content can be delivered as a coupon displayed in the interface. The registrant can print the display at 910, which can include, for example, a bar code encoding the registration account information for the registrant. One example coupon is shown in FIG. 5. The coupon can also be configured to display any additional requirement for completing redemption. At 912, the registrant begins redemption by taking the coupon to the establishment indicated on the coupon. The coupon is scanned at 914, which can be configured to trigger a communication from the establishment to the registration system. The communication indicating the redemption activity can trigger the registration system to change the status of the registered account location. For example, the registration account can be flagged as “scanned but not active.” The change in status can be associated with deadlines requiring a registrant to perform required actions by a specific time in order to redeem incentives. At 916, the registrant returns to the registration website and logs into their account providing their credentials for the registration system and the player club account that they were required to sign up for. Additionally the registration system can prompt the registrant to enter additional information on other external accounts. A registration system and/or an engagement system can be configured to merge the external accounts identified at the registrant's subsequent return to the registration site. Further the registration site can be configured to permit redemption and/or gaming activity associated with the incentives and content.

According to one embodiment, once the player accounts are matched and merged, the internal and external systems can be configured to benefit from continued interaction with the player. Information and data obtained about the player from one system can be transferred to the other system(s) and used to supplement the profile and understanding of the player by all participating systems. For example, an external system that gathers additional demographic information on the player via surveys or questionnaires can then associate that information to the player identifier and pass that information on to the other systems. The internal system may then use that information to refine its profile of the player and to determine and deliver more current incentives to the player based on that information. In another example, it is appreciated that the regency of interaction with a player can be a critical measure of the status of the player. By having the player account merged between internal and external systems, the breadth of opportunities to interact with the player is significantly expanded and the information gained from those interactions can be shared amongst all the systems.

In another aspect of this invention, it is appreciated that the incentive for matching and merging the accounts is that certain benefits accrue for a registrant that is both a member of the internal system and the external system. It is also appreciated that having a registrant of the internal system receive those external system benefits for a limited time before registering for the external system encourages the registrant to ultimately register for the external system. However, there may exist a delay between matching/merging and becoming permanently eligible for the external system benefits. In one aspect of this invention, matching and merging the two accounts extends the time during which the registrant receives those external system benefits.

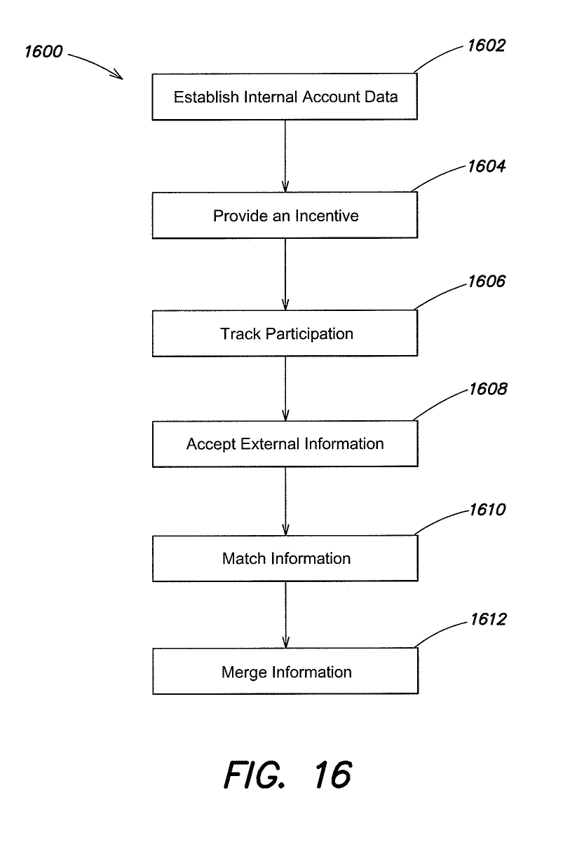

An example merge and/or reconciliation process is conducted in conjunction with online gaming activity designed to attract potential players. Shown in FIG. 16 is an example process 1600 for providing an incentive to facilitate merging of external and internal account information. In one example, an online game provider can have a relationship with an external service provider, who compensates the online provider based on the online provider directing new customers to the external service provider. In another example, an online gaming provider can have a relationship with a gaming provider (e.g. a casino) which compensates the online provider for each new player. According to one aspect, providing integrated match and merge operations for account information associated with the online gaming users held by the online service provider stored on its internal systems to account information associated with casino players stored on the casinos systems (an example external system) facilitates engaging new players and delivering targeted services to the users of both the casino and the online gaming site.

In one example, process 1600 can be executed on or in conjunction with an online gaming environment. A user accesses an online interface to establish an account with the online game provider. At 1602, the game provider's system establishes internal account data for the user accessing the online interface. The internal account data can include personal information associated with the user (e.g. likes, dislikes, interests, hobbies, etc.), and can also include demographic information (e.g. age, address, occupation, etc). The online gaming system generates a unique identifier for each user account which includes the internal account data. The unique identifier permits the internal system to retrieve user information and any external account information associated with the account record. The internal account data can also be used by the internal system to identify incentives targeted specifically to the user based on the information provided at 1604. Probabilistic analysis can be employed to identify offers that the user will be more likely to redeem. Additionally, in some embodiments, specific external accounts can be selected by the internal system for which the user will be more likely to complete registration. In one example, external accounts can be selected based on proximity to the user's address information, in another, external accounts aligned with the user's stated, modeled, and/or predicted interests can be selected. In other settings, user models can be employed and matched based on user entered demographic information. The player models can be configured to establish probabilities for completion of registration with a variety of external systems. In some examples, incentive offers can be selected randomly or can be selected based on predetermined criteria.

In one alternative, the internal system can be configured to present the user the option of selecting an external account that the user would be interested in creating. In another alternative, the user can be provided the opportunity to select an external account and the incentive offered tailored to the selection of the external account at 1604. Various external accounts can be associated with a particular value to the gaming operator. In one example, the external account is associated with a gambling location (e.g. a casino) and the external account is the associated playerclub membership club provided at the gambling location.

In some settings, the value for a particular external account can be established by the online gaming operator. In other examples, an external account provider can have established with the online gaming provider compensation schedules for the creation and/or activation of new accounts which define the compensation value for each account. The external account provider can also sponsor particular online games as well as the incentive offers associated with creating and/or activating an account with the external account provider. The sponsor can also be an independent entity. The external account provider/sponsor can provide criteria associated with incentive offers and reimbursement to the online gaming operator for completed registrations. In some settings, a casino operator can sponsor online games through an online game provider and defined incentives that the online game provider will offer to drive players to the casino operator's physical location and/or online presence.

A online game player can take an incentive offer to an external account location to redeem the incentive. Typically, the incentive includes information on any requirements to redeem. The requirements can include designated external account locations, specific time periods in which the offer can be redeemed, etc. In one embodiment, the incentive is configure to require the online game player to create and/or activate an account with the external account system. At 1606, the online game systems (the internal system) tracks player participation in the incentive offers, by receiving redemption information from the external account location. For example, a player given free gabbling play at a casino as the incentive can be required to sign up for the casino's playerclub membership in order to receive the free gambling play. The casino systems (the external systems) are connected over a communication network to the internal system of the online game provider. In one example, the incentive can be associated with a unique identifier for the internal system of the online game provider so any information can be associated with an account record. In another example, the user is required to provide identifying information during the creation and/or activation of the external account. At 1608, information associated with the newly created/activated external account and any external account information can also be communicated as part of the redemption process.

At 1610, the online gaming system matches the received information with existing account records. According to one embodiment, the matching process can identify a unique user identity associated with the received information and match that directly to an account record. In another embodiment, the online gaming system is configured to match information submitted during creation and/or activation of the external account to information existing on the online gaming system. The information can be matched on name, date of birth, government issued identifiers (e.g. driver license number), as some examples. The online gaming system can also be configured to identify potential matches between received information and existing accounts. Potential matches can be determined based on a degree of similarity. In some embodiments, a threshold can be established to determine if the match is sufficiently close to qualify for merging of the received external account information to existing account information. The threshold can reflect a degree of probability that the potential match is an accurate match, and the system can be configured to require a certain probability before executing a merge process.

At 1612, received information is merged with a user account on the internal system. Some incentive offers provided at 1604 can required creation and/or activation of an external account and moreover can also require submission of authentication information used to access the external account. In some embodiments, the online gaming system can be configured to validate the received information before merging the received external account information. In one example, the online gaming system can be configured to automatically access external accounts based on the received information and only upon a successful login validate and merge the received information, for example, at 1612. In another example, the online system can confirm the external account information received using authentication information already stored in the user account on the internal system to automatically log into the external account. Further, received information can be validated against existing information stored on the online gaming operator system.

In some embodiments, redemption of an inventive, for example, provided at 1604 can require a validation message be transmitted from the online gaming provider to the external account provider, prior to delivering any benefit associated with an incentive. In other examples, redemption can be based on creation and/or activation of an external account.

Shown in FIG. 14 is a block diagram of an example system 1400 for engaging and acquiring new customers. System 1400 includes at least one server 1402 having at least one processor coupled to a memory element that permits execution of computer based instructions. The memory element can include both transitory and non-transitory memory components. Server 1402 can include a database stored in memory 1404. Typically server 1402 is configured to provide online access to games to a plurality of players through a network connection 1406. Network connection 1406 can include LAN and/or WAN connections, including for example the Internet. Players can access the game server 1402 from a host computer 1408 connected to the network 1406. Incentive offers can be delivered to the host computer and printed on a connected device 1410.

Server 1402 can be configured to permit access to any user accessing the server online In some embodiments, access can be restricted to registered users. In other examples, registration can also include verification of registration information, including for example, verification of age. System 1400 can include a registration component implemented in hardware and software that is configured to accept and stored account data associated with a user record. The registration component can be implemented on server 1402 or can be implemented on additional system(s) connected to server 1402. System 1400 can also include a matching component configured to analyze an existing user account stored on the system with external account information. The system 1400 can also includes an incentive component configure to provide at least on incentive to a user. The incentive component can be configured to identify an incentive based on information associated with the user, and/or based on qualifications defined for the incentive. In some examples, the incentive component can be configured to identify a plurality of incentive offers. In one example, a user can select an offer from among the plurality of incentive offers. The system can provide the selected incentive, which can be associated with a requirement to activate and/or create a specific external account with a specific external account provider. Alternatively, the system can match a requirement to activate/create an external account to the incentive based on information known about the user or the system can match a match a requirement to activate/create an external account based on a value of the incentive and/or a value associated with the creation of an external account.

In some embodiments, the system 1400 can be configured to associate incentives offers to external accounts based on the value associated with the creation of the external account. In one setting the online game provider can be compensated based on each created/activate account by the external account provider. The system can select the requirement for an incentive to include the external accounts deemed most valuable. The selection process can be configured to include likelihood of redemption in addition to the value associated with the creation/activation of the external account. For example, likelihood of redemption can be configured to analyze player affinity for a particular external account, among other options. In one embodiment, a particular external account target can be predefined as part of a particular offer. In some embodiments, the external account provider can sponsor the offer being provided and thus the external account provider can dictate what redemption criteria can be employed.

In other embodiments, system 1400 can be preloaded with external account information provided by an external account provider. The preloaded external accounts can be specially created by the external account provider in advance, or reserved by the account provider to accommodate redemptions of incentive offers. When the system 1400 has external account information preloaded, the incentive offers can be tailored to include the preloaded external account information. This can permit the external account provider an opportunity to validate redemption of incentive offers based on the provided information as well as any validation communication between the internal and external systems.

According to some embodiments, in order to redeem the incentive, the user must activate the external account, which can requires input of additional information and establishment of authentication information for the external account. The external account system can be configured to transmit that information to the system 1400 as part of a redemption process.

System 1400 can include a validation component configured to validate external account information received. For example, the external account information received by system 1400 can include an external account number and authentication information for the external account. The validation component can be configured to automatically log into the external account using the provided information, and upon a successful login validate the received information. The validation component can operate in conjunction with a redemption component of system 1400. The redemption component can be configured to require the activation and/or creation of an external account in order to receive a benefit from an incentive offer.

In one environment, the server 1402 can be configured to operation as the internal system which can be connected via 1406 to an external system (not shown). FIG. 15 is a block diagram of an example system 1500 for engaging and acquiring new customers. System 1500 can be configured to provide an external account system that is the subject of an incentive offer designed to get an online player to create and/or activate an external account. An external system 1500 can be connected to an internal system (not shown) for providing incentive offers configured to require creation and/or activation of external accounts on system 1500.

System 1500 can include for example a casino management server 1502. Casino management server 1502 can be configured to manage creation and maintenance of casino player accounts and can be further configured to track play activity as well as promotions offered by the casino. Account information and player profile information, for example, can be stored in a database 1504 on server 1502. Sever 1502 can be connected via a network 1506 to various computer systems located at the casino, including gaming systems, host computers, etc. Further server 1502 can be connected to computer system outside the casino. Network 1506 can encompass multiple LAN and/or WAN networks. In one example, server 1502 is connected to a redemption terminal 1508. Redemption terminal 1508 can be configured to redeem a printed incentive offer delivered to an online player. Redemption terminal 1508 can include a scanner 1510 for capturing information from a printed inventive offer. In some settings, information can be encoded on the printed offer in the form of a bar code, and the scanner 1510 can comprise a bar code scanner. In some settings, the scanner can capture an electronic image of the printed offer and the redemption terminal, the scanner, and/or server 1502 can be configured to provide for optical character recognition to capture information from the offer.

In one embodiment, the online gaming environment typically requires a registration in order for the online player to participate. Although, introductory games can first be offered, with registration following online game play. In one embodiment, a first step in acquiring a new player can involve attracting the new player to play the online game. Typically, the online game provides various style awards opportunities having various award amounts. These opportunities are provided with limited information on the particular player. Typically, in this setting, actual redemption of these awards is low, presumably because the awards are being provided without much information beyond registration information (e.g. a signup e-mail and possibly date of birth information). Additionally, a game operator has criteria for providing awards that must not be exceeded, or in some examples, the game operator may receive explicit instruction on what incentives to provide and at what value.

Once an award opportunity is provided to a potential player that intrigues that player enough to actually redeem it, the redemption process can include requirements for providing and/or establishing an external account (e.g. a playerclub membership). Once the external account is created a merge process can be employed to incorporate external account information into an internal system provided by the promotion operator. In one example, the online game provider maintains an internal system and registration information for playing the online game, and during or after redemption of an opportunity, external account information is received and incorporated into the internal system's stored data. The stored data can be used to verify matched information before merging internal and external account information.

External account information can be received in conjunction with a redemption process. For example, an online award opportunity can prompt a user to print a coupon, and redeem the coupon at a gambling establishment. Redemption of the coupon can require creation of a playerclub membership. During or shortly after redemption, a validation process is typically conducted to insure a valid coupon is being redeemed. The new player club membership information can be submitted during validation, providing the information for subsequent merge and/or verification processes. In one alternative, unassociated external account identifiers (e.g. player club account numbers) can be provided to the internal system and any unassociated external account identifier included on any redemption information. The player redeeming an award will typically be required to submit information to associate with the external account, and that information transmitted to the internal system for subsequent merger processing. Other external account targets can be specified by the internal system. For example, the internal system can be configured to require registration with a lottery retailer. In another example, the internal system can be configured to require registration with an affiliate who provides customer membership services.

In another embodiment, online player accounts are associated with a status. In one embodiment, the status is designed to limit player participation after a certain time. Additionally, the associated status can be used, for example, to limit the value of award opportunities or to increase the value of the award opportunities. The status can be used to prompt the online player to take an action and/or redeem at least one award opportunity. The activity can be linked to a time period to spur activity within a given time frame. Where the desired activity is creation of an external account, redemption of an award can be configured to require creation of an account or submission of existing account information. In response to account creation, player status can be updated to reflect completion, and internal and external account information can be merged. Typically, this can occur in conjunction with redemption. In some embodiments, this occurs in real time, in other examples as a batch process. Optional verification steps can be performed to insure a valid match before account information is merged. Various thresholds can be employed to determine if a valid match has occurred. For example, exact data matching can be required. In other examples, match of name and date or birth may be sufficient, as players may have more than one e-mail. Where e-mail information does not match additional information can be required to verify a valid match. Additionally the internal system can be configured to identify matches with spelling errors and other close but not exact matches.

### Communication & Content Delivery

In one aspect of this invention, a communications component is provided that enables the operator the ability to send out general, segmented or targeted communications to registrants of a registration system

For example, the operator may want to communicate an upcoming product offering to members of the system. So, the system provides the capability for the operator to configure content to be communicated and the delivery method. Delivery methods can be but are not limited to:

a. Postcards or regular postal mail

b. An automated phone message

c. An Email

d. An SMS message

e. A message through a website or social network

f. A message delivered electronically through a WAN or LAN network

In another aspect of this invention, the registration system can deliver these messages to the entire database or a segment of the database based on particular data attributes related to the account.

For example, the operator may want to advertise an upcoming product to the entire database. Or, the operator may want to only send the communication to males between the ages of 35-55.

In another aspect of this invention, the registration system can deliver messages to a targeted group of registrants based on activity or actions.

For example, the system is directly connected to a device at the point of sale. When a registrant makes a purchase, they identify themselves by using a loyalty card or entering a username or pin at the point of sale device. They can then be presented with the option to purchase using cash, or using a credit card associated with their account on the system. The user selects to purchase using the system-linked credit card. The system recognizes they have made a purchase and will send them a follow-up email communication confirming the purchase at the point of sale. This is useful because it allows users to be notified when transactions occur related to their credit card and the system.

As another example, an email communication can be configured to be delivered to every player that redeems a coupon that they received and printed via the casino and/or lottery's website. This communication is directly triggered off of the action taken by the user to redeem the coupon.

In another aspect of this invention, the operator may want to communicate to a wide audience, using terminal devices at the point-of-sale location. A registration system can be configured to deliver messages, advertising, slideshows, videos and other collateral to these devices in real time.

For example, the system can be configured to release advertising related to a particular gaming product to coincide with the product launch date. When that date and time is reached, the system pushes this data to these devices in real time in order to deliver the content related to the particular gaming product.

### Incentivizing and Awarding Online Registrants

In one aspect of this invention, benefits normally provided to members of a casino or lottery player club are configured into the registration system to be provided as an incentive to potential new registrants of the system.

For example, player club members may be made eligible for particular incentives and awards. The system will recognize the eligibility for these incentives and rewards and make new registrants of the system eligible for those rewards as well.

In one aspect of this invention, incentives and awards made available to new registrants can be rule based.

For example, when a new registrant comes to the website for the fourth time, the system is configured to automatically offer a new award, such as a second chance interactive reveal game, where the player reveals $10.00.

In one aspect of this invention, incentives and awards made available to new registrants can be based on a set of one, many or a combination of rules and conditions.

For example, when a new registrant comes to the website for the fourth time, the system is configured to automatically offer a new award, such as a second chance interactive reveal game, where the player reveals $10.00, but they must redeem within 24 hours at a retail location in order to receive the award. Various promotions and example awards options are illustrated in FIG. 6.

As another example, new registrants in the ‘active’ state get better rewards than registrants with accounts in ‘non-active’ or other account states. For instance, ‘active’ accounts receive ‘4×’ any amount of sweepstakes entries awarded.

In another aspect of this invention, incentives and awards exposed by a registration system can be based on actions taken by the new registrant or their behavior

For example, the new registrant may use their cell phone to send a text message to a particular phone number with the text ‘WIN’. The system than recognizes their phone number as being associated with their account and enters the new registrant into a sweepstakes.

As another example, the operator can configure the system to offer particular incentives to align with sales initiatives. If an operator desires to drive more on property or retail visits, they can offer coupons that require redemptions and configure them with shorter expiration dates. If an operator desires to drive more on-line subscriptions, on-line play or product purchases, they can offer real-time incentives and discounts for those behaviors.

In one aspect of this invention, a registration system awards incentives that require complete club registration in order to redeem the offer.

For example, if the offer is $100 in ‘free play’, the offer is only valid if the system can recognize that the user has completed each step required in the registration process, scanned a coupon on property and has created an account in the external account system. Only then will the player be given the opportunity to use that $100 in ‘free play’.

In one aspect of this invention, the system make a registrant eligible for incentives and awards based on a score that has been produced by the system based on statistical analysis of account data, location and behavioral profiling.

For example, specific account data can be used to determine average income, gender and age. This data can then be fed through scoring functions, which can be but is not limited to, statistical models, predictive analysis and regression tests, to produce a score that can then be used to determine which incentives and awards the player should be eligible for.

In another aspect of this invention, if expiration times are tied to particular steps in the new player registration process, the expiration of those steps can be tied to specific system events. Some of these events can be used to add additional incentive for the completion of the new player registration process.

For example, if the new registration revealed $10 in ‘free play’ and is within 24 hours of that coupon expiring, the system can trigger an email communication to notify the new registrant that they should redeem the coupon soon.

As another example, when a coupon expires, the system can trigger an email communication offering the player one more 24-hour period to redeem, extending the previous expiration time by 24 hours.

In another aspect of this invention, new registrants are offered a chance to participate and receive awards on a particular schedule.

For example, players will receive a new chance to reveal an award or incentive every minute, hour, day, week, month, year, etc.

In another aspect of this invention, new registrants are offered a chance to participate and receive awards based on a schedule of fixed outcomes.

For example, the system stores in memory, on disk or in a database the exact sequence, dates and times that a particular new registrant will receive a particular reward.

In another aspect of this invention, interactive game competitions and tournaments for incentives and awards are used to incentivize engagement.

For example new registrants can return to a website at a predefined time or anytime and compete for the highest score in a game of solitaire. At the end of a configured competitive period, the system measures all of the scores in the game of solitaire and awards the incentive or award to one or many winning participants.

In another aspect of this invention, awards and incentives can be based on community activity.

For example, players can become captains of teams that “compete” against each other for incentives and awards, such as sweepstakes entries and coupons.

In another aspect of this invention, eligibility for participation in an award can be based on the number of friends that you refer to the system.

For example, when a registrant invites a friend to participate and the referral completes a predefined set of required actions, such as registering for an account online, at the gaming property, or at a lottery retailer, the registrant receives additional incentives, such as ‘10×’ sweepstakes entries.

In another example, if the referral wins a particular sweepstakes, the registrant could also receive a win for being the person that referred that referral.

### Building a Currency for Engagement and Driving Loyalty

In one aspect of this invention, a currency such as but not limited to sweepstakes entries, points or a cash equivalent currency is used to drive behavior and incentivize engagement with the system. A registration system can be configured to recognize and track interactions with the system and based on predefined rules, awards this currency to players.

For example, a lottery player that enters in the identifiers from 10 losing lottery tickets is randomly awarded 0-100 sweepstakes entries for each losing lottery ticket.

In another aspect of this invention, if the currency is sweepstakes entries, they can be entered in to one, many or a combination of sweepstakes.

For example, when a user is awarded sweepstakes entries, they are then given the ability to apply one, many or all of their entries awarded into a one, many or all of the sweepstakes. They are provided a display of the total number of sweepstakes they have entered into the system thus far, and how many entries they have entered into each sweepstakes.

In another aspect of this invention, users awarded sweepstakes entries can “bank” or store those entries for later use.

For example, entries can be stored by the user and applied to sweepstakes in the future.

In another aspect of this invention, sweepstakes can have an expiration or “use by” date.

For example, if the user is provided the ability to “bank” or store sweepstakes entries, they must apply them to a sweepstakes before the expiration date, otherwise those entries are invalid.

In another aspect of this invention, the sweepstakes entries can be applied to a “wide-area” or “pooled” sweepstakes prize.

For example, many state lotteries may desire to join together to create a very attractive combined sweepstakes prize. This sweepstakes can then be entered into from multiple sources.

### Tracking & Scoring

In one aspect of this invention, a registration system tracks particular engagement with the system and builds a profile related to the registrants account for the purpose of optimizing future marketing and incentive targeting.

For example, the system can track interactive content that the registrant engages with in order to build a profile on game affinities.

In one aspect of this invention, the operator can choose to ‘cap’ or ‘hide’ or ‘limit’ particular data elements related to the account and the profile.

For example, some operators do not want specific demographic information on the player, but they may want to track particular play with interactive online games. These operators need a system to track play and build certain profile information in an acceptable way. So, the system can be configured to only track play and apply that to build profile based on game affinities, but can also instruct the system to ignore all other tracked data.

In one aspect of this invention, a registration system tracks referrals into the registration process.

For example, the system stores in memory, on disk or in a database a unique set of identifiers that define a source of a referral, such as but not limited to an individual, a web site, a corporate entity, a radio station, or print media. This referral tracking data can then be used by the system to score the performance of particular referral sources and provide that data to the operator.

In another aspect of this invention, a registration system tracks and scores the performance of particular incentives delivered by the system.

For example, the system measures response, redemption rates, and participation related to a particular incentive and can use that data to determine which awards and incentives are most effective at delivering particular results related to the system. This data can then be used to adjust the amount, frequency and targeting of awards.

In another aspect of this invention, a registration system builds a profile of the registrant and continually evolves that profile based on measurement and tracking of actions taken by the registrant with the system. This profile can then be used to determine awards and incentives for the registrant, or to determine how best to drive desired behavior.

For example, indicia used to measure and track actions taken by the registrant are, but are not limited to, the following:
a. Duration of time it takes to complete particular required steps in the registration process.
b. Games and content that the registrant engages with
c. Data from questionnaires and quizzes taken by the registrant
d. Number of times a registrant returns to the casino gaming or lottery website
e. The number of time the registrant completes a transaction at the casino gaming facility or lottery retailer.
f. Demographic information
g. Psychographic information
h. Income
i. Location, zip code
j. Current geo-location

Various aspects of the invention are described herein with reference to a registration system, a management system and/or an engagement system. One should appreciate the teachings disclosed with respect to the various systems is not limited to the particular system and can be combined and/or used in conjunction with the other systems and the various elements disclosed with respect to individual systems can be used with other systems as disclosed herein.

Various embodiments according to the present invention may be implemented on one or more computer systems. These computer systems may be, for example, general-purpose computers such as those based on Intel Atom, Core, or PENTIUM-type processor, IBM PowerPC, AMD Athlon or Opteron, Sun UltraSPARC, or any other type of processor. It should be appreciated that one or more of any type computer system can be used to provide access to registration systems, incentive offers, incentive content, to provide for new user registration, entry of external account information, scoring players, tracking registrant activity, tracking gaming activity, redemption of incentive offers, communication between external account systems and registration, engagement, and/or management systems, building player profiles and qualifying registrants for particular content and incentives. Further, the system may be located on a single computer or may be distributed among a plurality of computers attached by a communications network.

A general-purpose computer system according to one embodiment of the invention is configured to perform any of the described operations and/or algorithms, including but not limited to providing for management of content, management of incentives, management of registration, registration of users, identification of external accounts, merging external accounts, display of user interfaces to host computer systems, tracking and analyzing player activity, building player profiles, among other options. It should be appreciated, however, that the system may perform other operations and/or algorithms, including operations for engaging and registering users, requesting information on external accounts, querying external accounts, communicating merge operations to external account systems, providing access to games, permitting selection of game subject, selection of game content, selection of incentives, and selection of external accounts, etc. The operations and/or algorithms described herein can also be encoded as software executing on hardware that define a processing component, that can further define portions of a specially configured general purpose computer, reside on an individual specially configured general purpose computer, and/or reside on multiple specially configured general purpose computers.

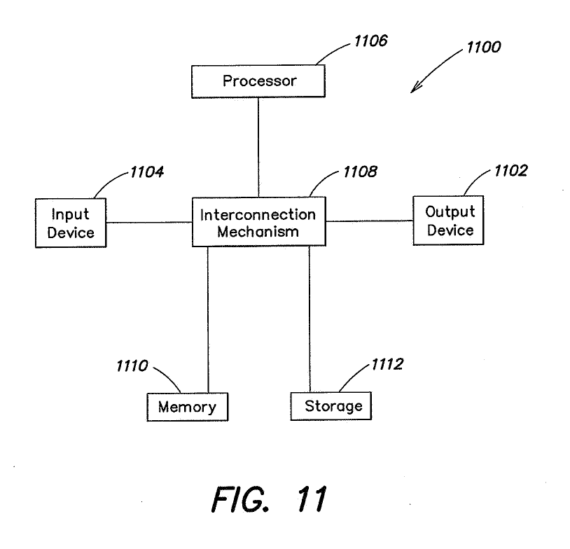

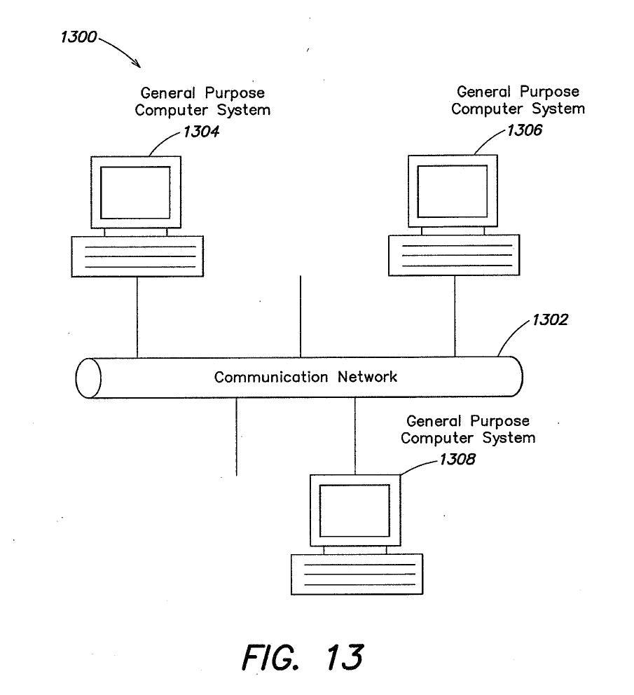

FIG. 11 shows a block diagram of a general-purpose computer system in which various aspects of the present invention can be practiced. For example, various aspects of the invention can be implemented as specialized software executing in one or more computer systems including general-purpose computer systems 1304, 1306, and 1308 communicating over network 1302 shown in FIG. 13. Computer system 1100 may include a processor 1106 connected to one or more memory devices 1110, such as a disk drive, memory, or other device for storing data. Memory 1110 is typically used for storing programs and data during operation of the computer system 1100. Components of computer system 1100 can be coupled by an interconnection mechanism 1108, which may include one or more busses (e.g., between components that are integrated within a same machine) and/or a network (e.g., between components that reside on separate discrete machines). The interconnection mechanism enables communications (e.g., data, instructions) to be exchanged between system components of system 1100.

Computer system 1100 may also include one or more input/output (I/O) devices 1102-1104, for example, a keyboard, mouse, trackball, microphone, touch screen, a printing device, display screen, speaker, etc. Storage 1112, typically includes a computer readable and writeable nonvolatile recording medium in which instructions are stored that define a program to be executed by the processor or information stored on or in the medium to be processed by the program.

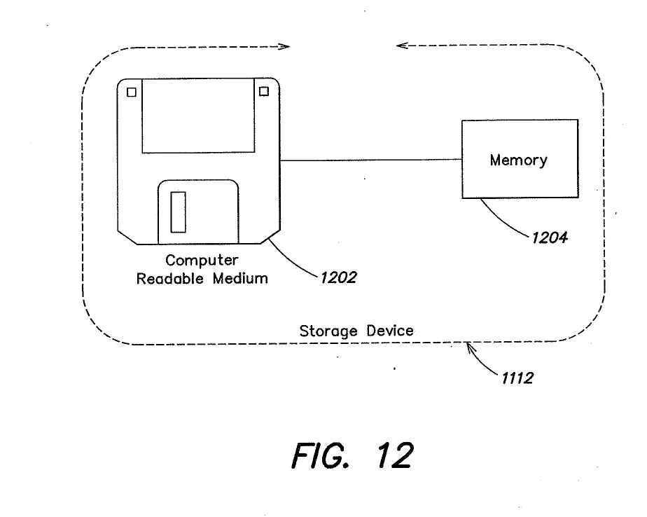

The medium may, for example, be a disk 1202 or flash memory as shown in FIG. 12. Typically, in operation, the processor causes data to be read from the nonvolatile recording medium into another memory 1204 that allows for faster access to the information by the processor than does the medium. This memory is typically a volatile, random access memory such as a dynamic random access memory (DRAM) or static memory (SRAM). In one example, the computer-readable medium is a non-transient storage medium.

Referring again to FIG. 11, the memory can be located in storage 1112 as shown, or in memory system 1110. The processor 1106 generally manipulates the data within the memory 1110, and then copies the data to the medium associated with storage 1112 after processing is completed. A variety of mechanisms are known for managing data movement between the medium and integrated circuit memory element and the invention is not limited thereto. The invention is not limited to a particular memory system or storage system.

The computer system may include specially-programmed, special-purpose hardware, for example, an application-specific integrated circuit (ASIC). Aspects of the invention can be implemented in software, hardware or firmware, or any combination thereof. Although computer system 1100 is shown by way of example as one type of computer system upon which various aspects of the invention can be practiced, it should be appreciated that aspects of the invention are not limited to being implemented on the computer system as shown in FIG. 11. Various aspects of the invention can be practiced on one or more computers having a different architectures or components than that shown in FIG. 11.

It should be appreciated that the invention is not limited to executing on any particular system or group of systems. Also, it should be appreciated that the invention is not limited to any particular distributed architecture, network, or communication protocol.

Various embodiments of the invention can be programmed using an object-oriented programming language, such as Java, C++, Ada, or C# (C-Sharp). Other object-oriented programming languages may also be used. Alternatively, functional, scripting, and/or logical programming languages can be used. Various aspects of the invention can be implemented in a non-programmed environment (e.g., documents created in HTML, XML or other format that, when viewed in a window of a browser program, render aspects of a graphical-user interface (GUI) or perform other functions). The system libraries of the programming languages are incorporated herein by reference. Various aspects of the invention can be implemented as programmed or non-programmed elements, or any combination thereof.

Various aspects of this invention can be implemented by one or more systems similar to system 1100. For instance, the system can be a distributed system (e.g., client server, multi-tier system) comprising multiple general-purpose computer systems. In one example, the system includes software processes executing on a system associated with conducting registration processes, and merging of external accounts, which can include operations such as providing a web based interface to accept registration information from a registrant, managing content and promotional offers for registered users, qualifying registrants for particular content or offers, scoring registrants based on input information, associating external accounts with a registration account, incorporating registration account identifiers in content and/or promotional offers, receiving information from external account systems, querying external account systems, identifying an merging external accounts, content delivery, offer delivery, providing a management interface to an operator, building player profiles based on entered information and/or merged information, identifying incentive offers, matching incentive offers to users based at least in part on player profile, matching incentive offers to users based on player score, validating external account information, as examples. These systems may permit the end users to access their registration information, access merged information, establish preferences associated with player information, access game information, access account information, access qualification requirements for promotions and/or incentives in data locally or may permit remote access to such content, the end users, for example, can employ a web browser to access a registration system, game content and associated information, access a web page to participate in bonus style games, and/or redeem awards provided through the registration system such that for example, external account information is provided and merged with a registration account.

There can be other computer systems that perform functions such as receiving and associating user account information with player club accounts, managing second chance games, managing game content, managing outcome generation and/or retrieval, among other functions. These systems can be distributed among a communication system such as the Internet. One such distributed network, as discussed below with respect to FIG. 13, can be used to implement various aspects of the invention.

FIG. 13 shows an architecture diagram of an example distributed system 1300 suitable for implementing various aspects of the invention. It should be appreciated that FIG. 13 is used for illustration purposes only, and that other architectures can be used to facilitate one or more aspects of the invention. System 1300 may include one or more general-purpose computer systems distributed among a network 1302 such as, for example, the Internet. Such systems may cooperate to perform functions related to registering players and/or merging accounts. In an example of one such system, one or more users operate one or more client computer systems 1304, 1306, and 1308 through which the user/player can access a registration system, access content, access promotions, enter external account information, and potentially redeem promotion and/or game benefits. It should be understood that the one or more client computer systems 1304, 1306, and 1308 may also be used to access, for example, account registration systems, engagement systems, scoring systems, operator management systems, etc. In one example, users interface with the system via an Internet-based interface.

In another example, a system 1304 includes a browser program such as the Microsoft Internet Explorer application program, Mozilla's FireFox, or Google's Chrome browser through which one or more websites can be accessed. Further, there can be one or more application programs that are executed on system 1304 that perform functions associated with registering users and/or merging external account information. For example, system 1304 may include one or more local databases for storing, caching and/or retrieving registration information, player profiles, player activity, registration account information, second chance credit balance, etc.

Network 1302 may also include, as part of the system for conducting second chance games, one or more server systems, which can be implemented on general-purpose computers that cooperate to perform various functions including accessing a second chance interface, entering identifying information, retrieving database information on a player, player profile and/or player accounts, executing interface processes between point of sale locations and a second chance game system among other functions. System 1300 may execute any number of software programs or processes and the invention is not limited to any particular type or number of processes. Such processes can perform the various workflows associated with a system for conducting second chance games and any associated methods.

Having thus described several aspects and embodiments of this invention, it is to be appreciated that various alterations, modifications and improvements will readily occur to those skilled in the art. Such alterations, modifications, and improvements are intended to be part of this disclosure, and are intended to be within the spirit and scope of the invention. Accordingly, the foregoing description is by way of example only.

What is claimed is:

1. A computer implemented method for providing incentives to engage and acquire new users and external relationships, the method comprising the acts of:
establishing, on a computer system, internal account data associated with a user record;
accessing, by the computer system, at least one incentive;
identifying, by the computer system, at least one external account target based at least in part on the internal account data associated with the user record;
providing, over a communication network, the at least one incentive to at least one user, wherein the at least one incentive is configured to require activation of the at least one external account target;
tracking, by the computer system, participation activity by the at least one user;
accepting, over the communication network, external account information associated with the at least one external account target, wherein the act of accepting includes permitting the at least one user to redeem the at least one incentive in response to activation of the at least one external account target;
matching, by the computer system, the internal account data with the external account information; and
merging, by the computer system, the external account information into the internal account data.

2. The method of claim 1, wherein the act of matching includes identifying a potential match between the internal account data associated with a user record and the external account information.

3. The method of claim 2, further comprising an act of verifying a potential match.

4. The method of claim 3, wherein the act of verifying the potential match, includes acts of submitting, automatically, by the computer system, authentication information obtained from the at least one user.

5. The method of claim 1, wherein the participation activity includes at least one of redemption of the at least one incentive, creation of an external account, activation of an external account, user activity associated with the external account, and the act of tracking participation activity includes at least one of accessing at least one external account automatically and receiving participation activity from an external account system associated with the external account information.

6. The method of claim 1, further comprising an act of updating a status of a user record, in response to the act of merging the external account information.

7. The method of claim 1, further comprising an act of incorporating the tracked activity into the account data.

8. The method of claim 1, wherein the external account information includes lottery account information.

9. The method of claim 1, further comprising an act of matching the user with at least one incentive based at least in part on the account data associated with the user, wherein the act of matching the user with at least one incentive includes acts of:
scoring a user based at least in part on account data;
generating an incentive for the user based on the user score.

10. The method of claim 1, wherein the internal account data is hosted by a an online gaming system connected to the at least one external account target by a communication network, and wherein the at least one external account target comprises at least one of a player club account managed by a gambling establishment and a membership account provided by a lottery retailer.

11. The method of claim 1, wherein the method further comprises an act of associating a pre-generated external account to the at least one incentive offer.

12. A system including at least one processor operatively connected to a memory for engaging and acquiring new users, the system comprising:
a registration component configured to accept and store account data associated with a user record;
a matching component configured to match the user record with external account information;
a merging component configured to merge external account information with internal account data;
an incentive component configured to:
identify at least one external account target,
provide at least one incentive to a user based at least in part on the internal account data,
require activation of the at least one external account target,
a tracking component configured to track participation by the user; and
a communication component configured to receive external account information communicated by an external account provider.

13. The system of claim 12, wherein the system further comprises a redemption component configured to validate the received external account information.

14. A non-transitory computer readable medium including instructions for performing a method for providing incentives to engage and acquire new users and external relationships, the method comprising the acts of:
establishing internal account data associated with a user record;
accessing at least one incentive;
identifying at least one external account target based at least in part on the internal account data associated with the user record;
providing the at least one incentive to at least one user, wherein the at least one incentive is configured to require activation of the at least one external account target;
tracking participation activity by the at least one user;
accepting external account information associated with the at least one external account target, wherein the act of accepting includes permitting the at least one user to redeem the at least one incentive in response to activation of the at least one external account target;
matching the internal account data with the external account information; and
merging the external account information into the internal account data.

15. The computer-readable medium of claim 14, wherein the act of matching includes identifying a potential match between the internal account data associated with a user record and the external account information.

16. The computer-readable medium of claim 15, wherein the method further comprises an act of verifying a potential match.

17. The computer-readable medium of claim 14, further comprising an act of verifying a potential match, wherein the act of verifying includes an act of submitting, automatically, by the computer system, authentication information obtained from the at least one user to the external system.

18. The computer-readable medium of claim 14, wherein the participation activity includes at least one of redemption of the at least one incentive, creation of an external account, activation of an external account, user activity associated with the external account, and the act of tracking participation activity includes at least one of accessing at least one external account automatically and receiving participation activity from an external account system associated with the external account information.

19. The computer-readable medium of claim 14, wherein the external account information includes lottery account information.

20. The computer-readable medium of claim 14, further comprising an act of matching the user with at least one incentive based at least in part on the account data associated with the user, wherein the act of matching the user with at least one incentive includes acts of:
scoring a user based at least in part on account data;
generating an incentive for the user based on the user score.

21. The computer-readable medium of claim 14, wherein the internal account data is hosted by a an online gaming system connected to the at least one external account target by a communication network, and wherein the at least one external account target comprises at least one of a player club account managed by a gambling establishment and a membership account provided by a lottery retailer.

22. The method of claim 1, wherein the method further comprises an act of associating a pre-generated external account to the at least one incentive offer.
